(19) United States
(12) Patent Application Publication
(10) Pub. No.: US 2007/0028220 A1
(43) Pub. Date: Feb. 1, 2007

(54) Fault detection and root cause identification in complex systems

(75) Inventors: William L. Miller, Dexter, MI (US); Kenneth Marko, Ann Arbor, MI (US); Dragan Djurdjanovic, Ann Arbor, MI (US); Jianbo Liu, Ann Arbor, MI (US)

Correspondence Address: MERCHANT & GOULD PC, P.O. BOX 2903, MINNEAPOLIS, MN, 55402-0903, US

(73) Assignee: Xerox Corporation

(21) Appl. No.: 11/454,618

(22) Filed: Jun. 16, 2006

Related U.S. Application Data
(63) Continuation-in-part of application No. 10/967,102, filed on Oct. 15, 2004.

(51) Int. Cl. G06F 9/44

(52) U.S. Cl. 717/124

(57) ABSTRACT

A system and method for detecting anomalies and identifying root causes of anomalies in a system are disclosed. The system includes anomaly detection agents trained to detect anomalies. The anomalies are known anomalies occurring in the system. The anomaly detection agents are interfaced with components of a tested system, and operate on one or more predetermined levels, such as hierarchical or threshold levels. The system also includes a root cause identification tool configured to identify potential root causes for anomalies occurring during actual operation of the tested system based on data from the anomaly detection agents.

### CROSS REFERENCE TO RELATED APPLICATIONS

The present application is a continuation-in-part of and claims priority to U.S. patent application Ser. No. 10/967,102, filed Oct. 15, 2004, the disclosure of which is hereby incorporated by reference.

### TECHNICAL FIELD

The present invention relates to software and systems, and more particularly to fault detection and root cause identification in run-time environments.

### BACKGROUND

In the current paradigm of product development, the quality of a product, its production, and its service is mainly designed, tested, and implemented during development. Anomalies in a product, its production, or its service are identified during development and corrected. Once a product is released, it is difficult to find remaining quality problems.

In the automotive industry, warranty repair is expensive and can consume a company's profits. Engineering is the root cause of more than fifty percent of warranty repair costs. Software, operating within the vehicle, is a core part of the engineering problem. Because engineering is often the root cause of the problem, swapping parts during the repair will not solve the problem.

Anomaly detection in complex non-linear systems, such as an automotive system, requires a high-fidelity model or representation of nominal system behavior that can be compared to actual system behavior to detect deviations. Such systems often require expert guidance or substantial computation time, due to which real-time monitoring becomes difficult. Furthermore due to the large number of inputs, environmental factors, and complex interrelationships in many such systems, the root cause for one or more anomalies is difficult to determine.

Therefore, improvements are desirable.

### SUMMARY

In accordance with the present invention, the above and other problems are solved by the following:

In one aspect of the present invention, a system for detecting anomalies and identifying root causes of anomalies in a system are disclosed. The system includes anomaly detection agents trained to detect anomalies. The anomalies are known anomalies occurring in the system. The anomaly detection agents are interfaced with components of a tested system, and operate on one or more predetermined levels, such as hierarchical or threshold levels. The system also includes a root cause identification tool configured to identify potential root causes for anomalies occurring during actual operation of the tested system based on data from the anomaly detection agents.

In another aspect of the present invention, a method for identifying root causes of anomalies in a tested system is disclosed. The method includes detecting anomalies in the tested system by generating comparison data representing a comparison between actual operational behavior of the tested system to normal operational behavior of the tested system. The method further includes compressing the comparison data into patterns. The method further includes determining a set of probable root causes for each of the anomalies based on the patterns generated from the comparison data.

In yet another aspect, a computer program product readable by a computing system and encoding instructions for identifying root causes of anomalies in a tested system is disclosed. The product includes instructions for detecting anomalies in the tested system by generating comparison data representing a comparison between actual operational behavior of the tested system to normal operational behavior of the tested system. The product includes instructions for compressing the comparison data into patterns. The product includes instructions for determining a set of probable root causes for each of the anomalies based on the patterns generated from the comparison data.

In a further aspect, a method of detecting a performance anomaly in a dynamic system is disclosed. The method includes identifying a current operational region of a plurality of operational regions based on the operation of the dynamic system. The method further includes comparing the operation of the dynamic system with normal operational behavior within the current operational region to calculate a performance indication of a degree of deviation from the normal operational behavior within the current region.

In still a further aspect, a computer program product readable by a computing system and encoding instructions for detecting a performance anomaly in a dynamic system is disclosed. The product includes instructions for identifying a current operational region of a plurality of operational regions based on the operation of the dynamic system, and for comparing the operation of the dynamic system with normal operational behavior within the current operational region to calculate a performance indication of a degree of deviation from the normal operational behavior within the current region.

The invention may be implemented as a computer process; a computing system, which may be distributed; or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its scope may be obtained from the accompanying drawings, which are briefly described below, from the following detailed descriptions of presently preferred embodiments of the invention and from the appended claims.

### BRIEF DESCRIPTION OF THE DRAWINGS

Referring now to the drawings in which like reference numbers represent corresponding parts throughout:

FIG. 1 is a schematic representation of methods and systems for root cause identification, according to an exemplary embodiment of the present disclosure;

FIG. 2 is a schematic representation of a computing system that may be used to implement aspects of the present disclosure;

FIG. 3 is a schematic representation of methods and systems for root cause identification, according to an exemplary embodiment of the present disclosure;

FIG. 4 is a schematic representation of methods and systems for root cause identification, according to an exemplary embodiment of the present disclosure;

FIG. 5 is a schematic representation of methods and systems for learning model-based lifecycle diagnostics, according to an exemplary embodiment of the present disclosure;

FIG. 6 is a block diagram of a development of a product; according to an exemplary embodiment of the present disclosure;

FIG. 7 is a schematic representation of the requirements associated with a wicked problem, according to an exemplary embodiment of the present disclosure;

FIG. 8 is a schematic representation of methods and systems for learning model-based lifecycle diagnostics, according to an exemplary embodiment of the present disclosure;

FIG. 9 is a schematic representation of methods and systems for learning model-based lifecycle diagnostics, according to an exemplary embodiment of the present disclosure;

FIG. 10 illustrates an example graphic user interface, according to an exemplary embodiment of the present disclosure;

FIG. 11 is a schematic illustrating a distributed system, according to an exemplary embodiment of the present disclosure;

FIG. 12 is a process diagram illustrating a vehicle product development, according to an exemplary embodiment of the present disclosure;

FIG. 13 is a process diagram illustrating the spiral lifecycle process, according to an exemplary embodiment of the present disclosure;

FIG. 14 is a process diagram illustrating the spiral lifecycle process, according to an exemplary embodiment of the present disclosure;

FIG. 15 is a process diagram illustrating the vehicle development phase, according to an exemplary embodiment of the present disclosure;

FIG. 16 is a process diagram illustrating how the lifecycle method progresses through requirements, according to an exemplary embodiment of the present disclosure;

FIG. 17 is a process diagram illustrating how the lifecycle method applies a spiral sub process, according to an exemplary embodiment of the present disclosure;

FIG. 18 is a process diagram illustrating how the lifecycle method is applied, according to an exemplary embodiment of the present disclosure;

FIG. 19 is a process diagram illustrating how the lifecycle method progresses, according to an exemplary embodiment of the present disclosure;

FIG. 20 is a process diagram illustrating how the lifecycle method applies a spiral sub process, according to an exemplary embodiment of the present disclosure;

FIG. 21 is a process diagram illustrating how the lifecycle method is applied in the spiral sub process, according to an exemplary embodiment of the present disclosure;

FIG. 22 is a system diagram, according to an exemplary embodiment of the present disclosure;

FIG. 23 illustrates how the lifecycle method links the levels together, according to an exemplary embodiment of the present disclosure;

FIG. 24 is a schematic representation of methods and systems for anomaly detection, according to an exemplary embodiment of the present disclosure;

FIG. 25 is a schematic representation of methods and systems for training an anomaly detector for a system, according to an exemplary embodiment of the present disclosure;

FIG. 26 is a schematic representation of methods and systems for anomaly detection, according to an exemplary embodiment of the present disclosure;

FIG. 27 is a process diagram illustrating an anomaly detection and root cause identification system, according to an exemplary embodiment of the present disclosure;

FIG. 28 is a schematic representation of an anomaly detection and root cause identification system, according to an exemplary embodiment of the present disclosure;

FIG. 29 is a schematic representations of methods and systems for training a growing structure learning system according to an exemplary embodiment of the present disclosure;

FIG. 30 is a schematic representation of an anomaly detection system, according to an exemplary embodiment of the present disclosure;

FIG. 31 is a schematic representation of a gasoline engine model system, according to an exemplary embodiment of the present disclosure;

FIG. 32 is a schematic representation of an integrated control system, gasoline engine vehicle model system, and anomaly detectors, according to an exemplary embodiment of the present disclosure;

FIG. 33 is a schematic representation of an anomaly detection system, according to an exemplary embodiment of the present disclosure;

FIG. 34 is a process flow diagram of an anomaly detection system, according to an exemplary embodiment of the present disclosure;

FIG. 35 is a schematic representation of a root cause identification system according to an exemplary embodiment of the present disclosure;

FIG. 36 is a schematic representation of a root cause identification system according to an exemplary embodiment of the present disclosure; and

FIG. 37 is a process flow diagram of an anomaly detection system according to an exemplary embodiment of the present disclosure.

### DETAILED DESCRIPTION

In the following description of embodiments of the present disclosure, reference is made to the accompanying drawings that form a part hereof, and in which is shown by way of illustration specific embodiments in which the invention may be practiced. It is understood that other embodiments may be utilized and changes may be made without departing from the scope of the present invention.

Increasingly complex and sophisticated control software, integrated sensors, actuators, and microelectronics provide customers with higher reliability, safety and maintainability. However, these impose more challenges than ever for today's engineers to diagnosis the vehicle and to detect and isolate system anomalies. The increasing portion of control software on a vehicle makes it even more difficult, because in order to reduce the cost, most of the manufacturers prefer the solution of designing more sophisticated control software, instead of adding hardware, to provide attractive features. The amount of software operating on a vehicle is unlikely to stop growing in the future.

The control software and various hardware components used on the vehicle usually exhibit nonlinear behaviors. This is especially true for control software. Therefore, once these software and hardware components are integrated in a vehicle and communicate with each other, they create a large number of operational regions. Those interactions are sometimes too complicated to understand even for experienced engineers. In addition, the driver inputs and external environmental conditions vastly vary and create infinite patterns of conditions in which the vehicle operates. Signatures describing system behaviors for different driver inputs and external influences are quite different. With infinitely many behavioral patterns, anomaly detection and localization are complex, because one has to compare the behavioral signatures to appropriate behavioral regimes. The best way to find anomalies is to compare the signatures within the same behavior regime, and the deviation of the current signature from a normal signature is the indication of the severity of the anomalies.

The present disclosure describes methods and systems for learning model-based lifecycle software and systems. More particularly, the software and systems typically include embedded diagnostic agents. These agents can include anomaly detection agents and diagnostic agents. The diagnostic agents can detect and quantify performance deviations or anomalous behavior. The anomaly detection agents detect and quantify performance deviations or other anomalous system behavior. Anomaly detection agents can be interfaced with a tested system to facilitate root cause identification in the tested system. These agents can incorporate Self-Organizing Maps and use, for example, Time Frequency Analysis or Local Models (such as local linear models) to detect anomalies in such systems. These agents can be incorporated into a variety of run time or development environments in order to diagnose errors throughout a product lifecycle.

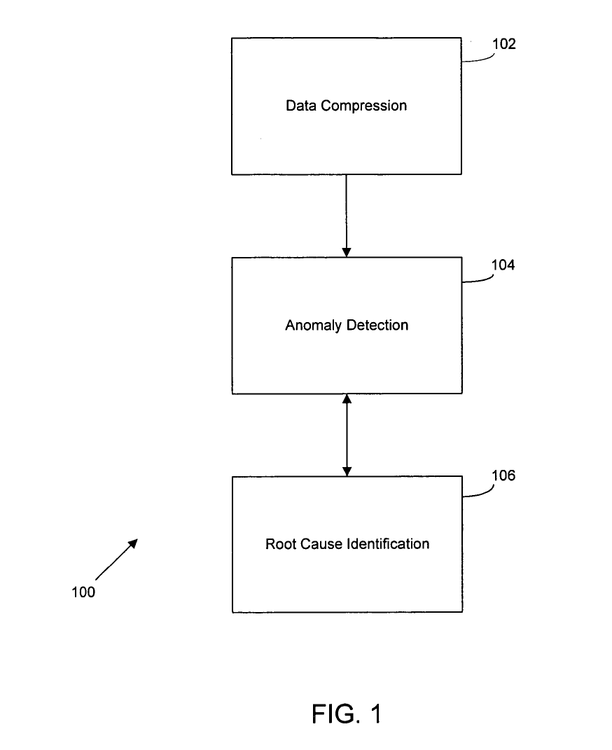

Referring now to FIG. 1, a schematic representation of methods and systems 100 for root cause identification is shown according to an exemplary embodiment of the present disclosure. In general, such methods and systems can be used for determining the cause of errors or other anomalous behavior in tested systems, and may be embodied in a variety of hardware or software tools. System 100 includes an anomaly detection module 102. The anomaly detection module 102 is configured to detect anomalies in a tested system. The anomaly detection module 102 compares actual operational behavior of the tested system to normal operational behavior of the tested system to produce comparison data.

The system 100 also includes a compression module 104. The data compression module 104 accepts the comparison data from the anomaly detection module 102. The compression module 104 creates patterns based on the comparison data.

The system 100 further includes a root cause identification module 106. The root cause identification module 106 generates a set of probable root causes for each of the anomalies detected by the anomaly detection module 102. The set may include one or more potential root causes of the anomaly, based on the patterns generated by the compression module 104.

The behavior of the tested system should be partitioned into a plurality of operational regions having predictable behavior. Normal operational behavior is determined within any operational region from performance related features extracted from a distribution or model in that operational region. The performance related features can be extracted from a time-frequency distribution. The model can be a local model of any form, such as a local linear model or a local recurrent neural network fitted to the signals emitted by the system in the operational region.

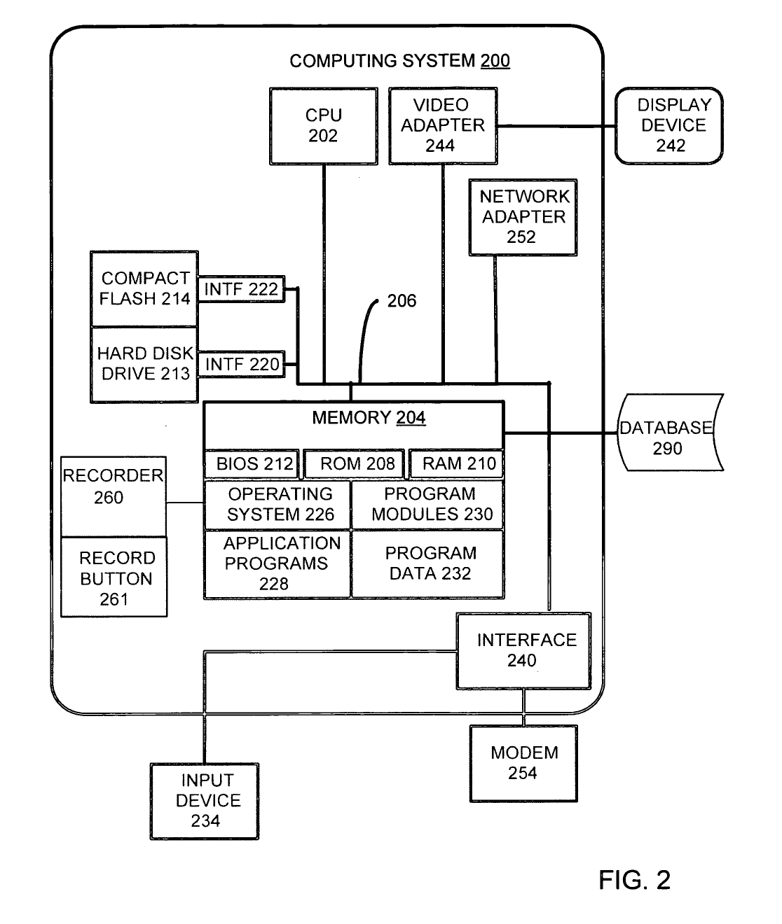

FIG. 2 and the following discussion are intended to provide a brief, general description of a suitable computing environment in which the invention might be implemented. Although not required, the invention is described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. In the exemplary computing system, these and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

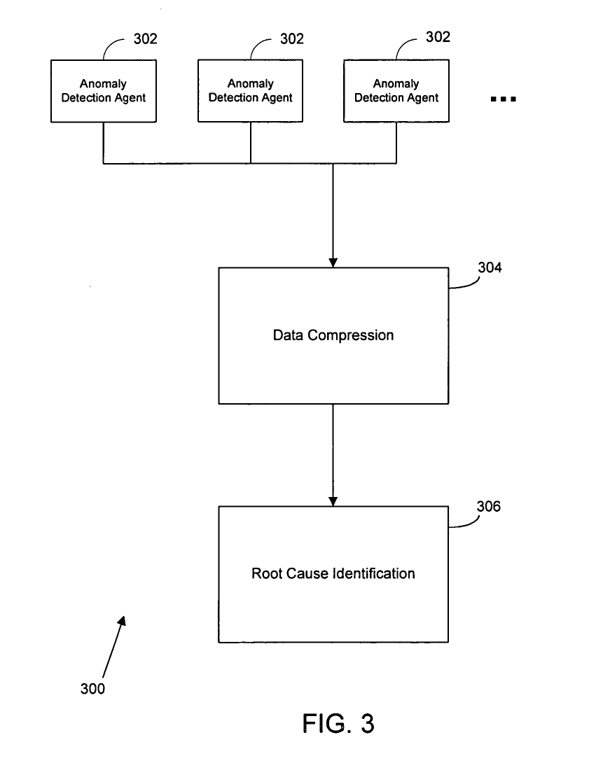

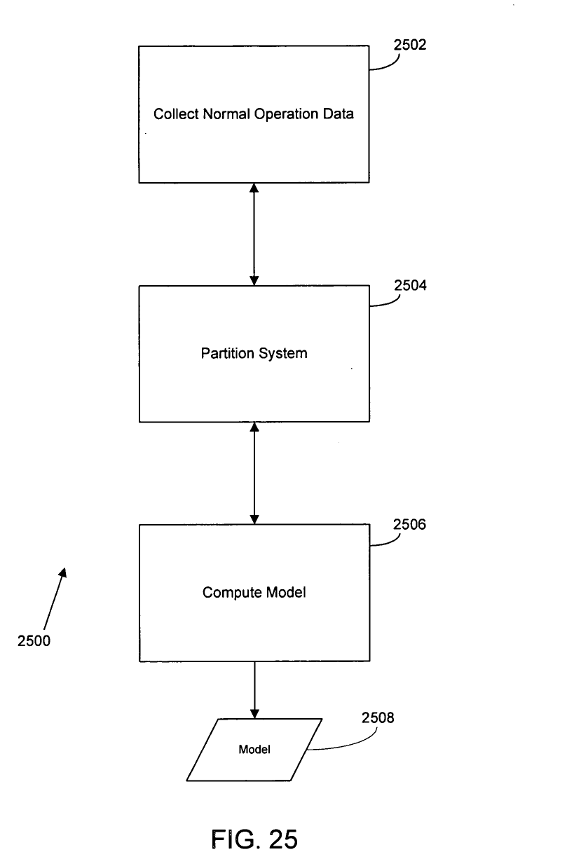

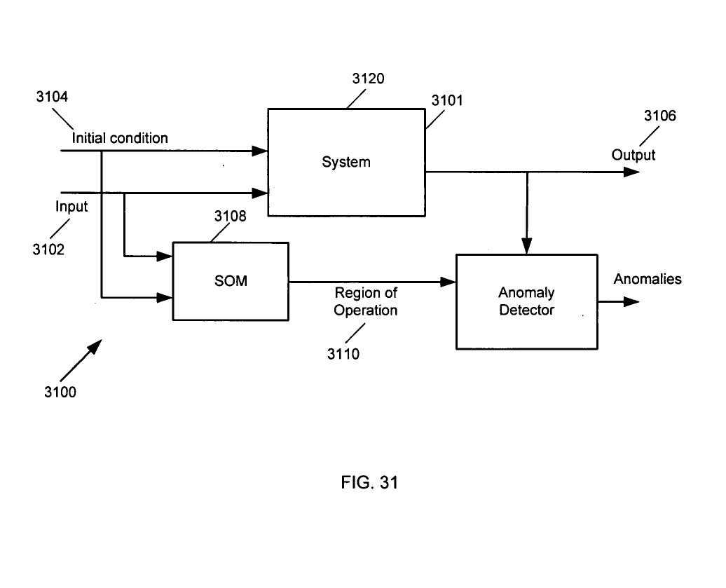

Referring now to FIG. 3, a schematic representation of methods and systems 300 for root cause identification are shown according to an exemplary embodiment of the present disclosure. In general, such methods and systems are used to provide an indication of possible sources of system misbehavior based on observations from a number of anomaly detection agents. Preferably, system 300 includes a plurality of anomaly detection agents 302. The anomaly detection agents 302 detect anomalies in a tested system. In preferred embodiments, the anomaly detection agents 302 are trained by observations of the tested system or portions of the tested system. The anomaly detection agents 302 can then derive statistical or model-based representations of system behavior to assess behavior of the tested system in unobserved situations. The diagnostic agents can be organized in hierarchical levels, as described in greater detail in conjunction with FIGS. 25 and 31.

The system 300 further includes a data compression tool 304. The data compression tool 304 is configured to partition the tested system into a plurality of operational regions. The data compression tool 304 is connected to the plurality of anomaly detection agents 302. The data compression tool 304 is configured to create patterns based on the comparison data. For example, the data compression tool may produce a statistical signature of the tested system's operation based on the output from the tested system within each of a number of regions. This pattern generation can be accomplished using principal components analysis (PCA) of time frequency moments of output signals.

The system 300 further includes a root cause identification tool 306. The root cause identification tool, in general, uses the patterns to determine possible root causes of the anomalies detected by the diagnostic agents. In various embodiments, the root cause identification tool can use the hierarchical and failure mode techniques described herein, such as in conjunction with FIGS. 31-33.

In an example embodiment, the anomaly detection agents 302 are configured in hierarchical levels with respect to the tested system. One anomaly detection agent 302 could monitor overall tested system inputs and outputs, while other anomaly detection agents 302 could monitor subsections of the tested system. The data compression tool can organize the detected anomalies into groups based, for example, on timing of the anomaly. The root cause identification tool 306 could then narrow the potential reasons for the anomaly by determining which anomaly detection agents 302 detected the error. Anomaly detection agents 302 connected to the anomaly-causing portion of the tested system will generally exhibit earlier or greater error rates that affect other portions of the tested system. In this embodiment, some knowledge of the hierarchical structure of the tested system is necessary.

In an alternative embodiment, the plurality of anomaly detection agents 302 can each be trained to detect a specific type or class of error of the tested system overall, in which case the agents 302 essentially become diagnostic agents. Each type of error, or “failure mode”, might be triggered by any of a number of anomalies in the tested system. By determining which anomaly detection agents 302 detect an anomaly, the root cause identification tool 306 can produce a set of possible root causes of the anomaly, allowing for more efficient detection/correction of design issues. This embodiment can be accomplished by training a diagnostic agent such as those described herein, with known error data in conjunction with system operation rather than completely normal functional system operation.

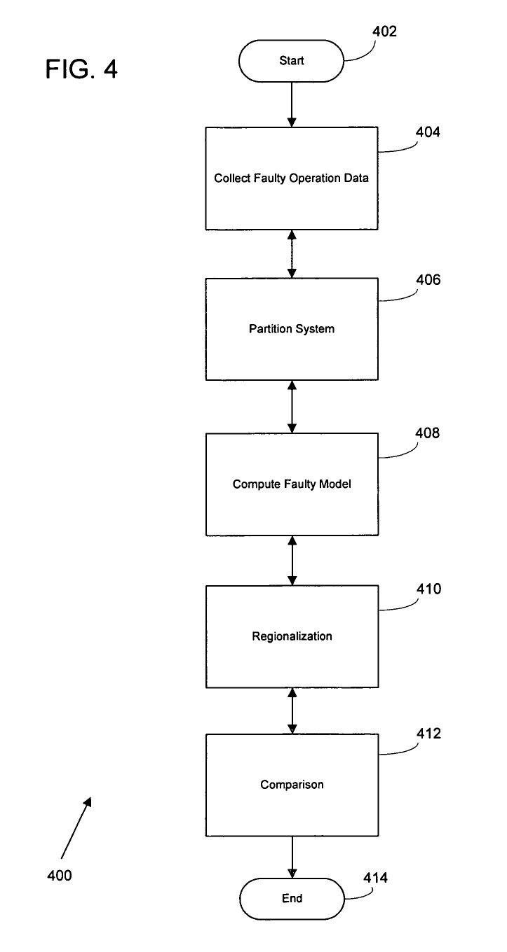

Referring now to FIG. 4, a schematic representation of methods and systems 400 for root cause identification are shown according to an exemplary embodiment of the present disclosure. In the embodiment shown, the root cause identification systems and methods are trained using a system with known errors in order to separate the known errors from newly-discovered anomalies.

The system 400, as shown, is instantiated by a start module 402. Following the start module 402, operational flow is passed to a collection module 404. The collection module 404 accepts anomaly data from diagnostic agents trained on a tested system. The anomaly data can be representative of anomalies sensed in the tested system. For example, the collection module 404 can accept known error values and known states for a tested system. The tested system can be a system for which certain erroneous operation is expected, for example, due to errors that are known but not corrected in the tested system. The training can be, for example, based on a recursive algorithm using Self-Organizing Maps to reach a designated variance or error level as discussed herein.

The system 400 includes a behavior partition module 406. The partition module 406 is configured to partition the behavior of the tested system into a number of operational regions. The partition module 406 trains a regionalization tool, such as regionalization module 410 below, in accordance with data. The data used to partition the tested system can be, for example, the normal or known faulty behavior-related data collected by the collection module 404.

The system 400 includes a compute module 408. The compute module 408 is configured to compute a distribution of signal features or a model of the known operational behavior. The distribution of signal features or model of known operational behavior can be based on the normal or known faulty behavior-related data collected by the collection module 404. The compute module 408 can do such a computation for each of the plurality of regions created by the partition module 406, and preferably does so for at least one of the plurality of regions of the tested system.

In the operation of one possible embodiment, the collection module 404, the partition module 406, and the compute module 408 execute concurrently. For example, the collection module 404 can collect a variety of data samples from a “baseline” operating system to be tested, generally a tested system including certain known errors. The partition module 406 may partition the tested system into a number of operational regions, or may partition those operational regions into a larger number of smaller-sized operational regions as additional anomaly data is collected by the collection module 404.

The compute module 408 can generate a model or statistical distribution, such as a linear model or distribution of time-frequency moments, from the collected data in the current operational region. The current operational region can be determined, for example, by a regionalization module 410, described below. The compute module 408 can update an estimated model or distribution using subsequent data it can receive from the collection module 404. Further, the compute module 408 can be configured to update or generate a model or distribution in other regions, such as neighbor regions to the current operational region.

The combination of the collection module 404, the partition module 406, and the execute module 408 produce a model or distribution of the tested system representative of normal or known faulty behavior in the operational behavior of the tested system based on the data collected by the collection module 404.

The system 400 further includes a regionalization module 410. The regionalization module 410 is configured to identify a current operational region in the tested system. The regionalization module 410 may accept as inputs the input and output of a hardware or software system to be tested. The regionalization module 410 determines the current operational region of the tested system from among the plurality of operational regions created by the partition module 406.

The system 400 includes a performance module 412. In operation, the performance module 412 compares actual operational behavior of the tested system in the current operational region to the known operational behavior of the tested system in the current operational region. The known operational behavior of the tested system is based on a model derived from the data that is collected from a tested system when this system behaved normally or when it underwent a known fault. This comparison determines if the actual behavior fits the expected fault. If it does not, the difference may indicate a newly-detected fault. This new error may in turn be an unexpected error and may have a new root cause.

The system 400 determines known operational behavior from an estimated model or distribution for the current operational region. The estimated model or distribution, as generated by the compute module 408, can be a local linear model or time-frequency distribution.

Operational flow among the operations 404-412 is generally ordered from training to testing. This does not necessarily dictate the order illustrated, although it is apparent that some amount of initial error data collection will take place before any partitioning module 406 can execute and the compute module 408 can derive a model or distribution. Furthermore, at least one operational region must exist for the regionalization module 410 to determine the current operational region, and some known and actual operational behavior must be available to determine performance in the performance module 412.

The system 400 terminates at an end module 414.

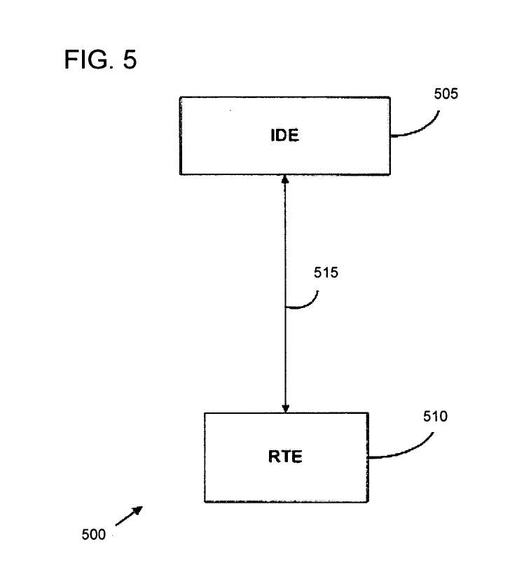

Referring now to FIG. 5, an example schematic representation of a learning model-based lifecycle system 500 is illustrated. The learning model-based life cycle described herein provides a construct upon which the root cause system is based. The system 500 includes an Integrated Design Environment (IDE) and a Run-Time Environment (RTE). The IDE 505 includes a set of software tools, or agents, linked within the IDE 505. The RTE 510 includes another set of software agents linked within the RTE 510. The IDE 505 and the RTE 510 are linked via link 515.

The root cause identification system and anomaly detection systems described herein can be incorporated in the IDE 505 or the RTE 515. When incorporated in the RTE, the root cause identification system and anomaly detection systems are configured in such a way that they provide real-time feedback and learning based on other elements integrated in the RTE 515.

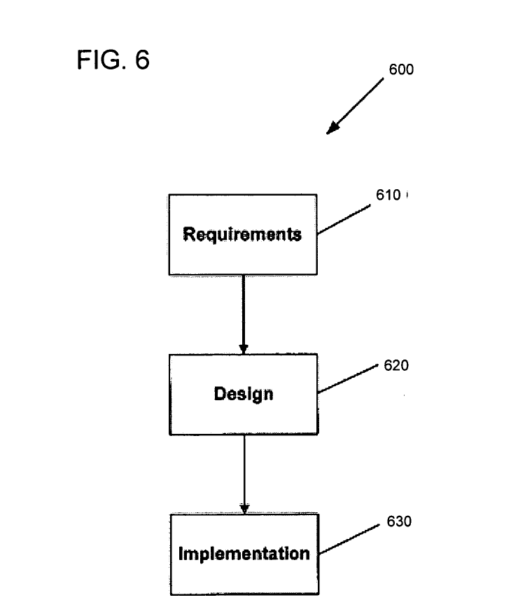

FIG. 6 is a block diagram illustrating a development system 600, which can include software and development tools. The development system 600 includes three basic types of components in the development of a product, for example, a vehicle. Block 610 is the requirements component. The first step in product and system development uses the requirements component. The requirements component defines what the product and system will include. Block 620 is the design component. After the requirements for the product and system are determined, the product and system are designed to conform to those requirements. Block 630 is the implementation component. After the product and system are designed, the product and system are manufactured according to the design component and put into service. The system can also include enterprise applications for supply and service chain integration. In addition, the system can include run-time application services including telecommunications and operations infrastructure and vehicles.

Using a vehicle as an example, a car manufacturer decides to make a new model X car with systems for learning model-based lifecycle diagnostics. At block 610, the requirements for the X car and systems are determined. For example, the X car should be a sedan having a certain payload, acceleration, and should not exceed $20,000. The system should reduce warranty repair costs and improve customer satisfaction.

At block 620, the X car and the systems are designed according to those requirements. The frame and suspension of the car are designed to carry the required payload, the power train is designed or chosen based on the gross vehicle weight and the acceleration requirement, and the rest of the X car is designed to not exceed $20,000. For example, knowing the X car should not exceed $20,000, an engineer may decide to choose an engine that barely meets the acceleration requirement and would not choose an engine that would greatly exceed the acceleration requirement. The system could be designed using web services with an imbedded web platform to run on a three-tier architecture consisting of servers, telematics, and electronics embedded in the vehicle. The system can have a distributed database to enable servers to be located throughout the supply and service chain. The system can include development, manufacturing, and service tools.

At block 630, the X car and the systems are implemented, i.e. manufactured and put into service, according to the design. Implementation deploys the software and hardware throughout the three-tier architecture in the supply and service chains.

Typically, software is utilized in each step of the product and system lifecycle, which includes product and system development, production, and service. Requirements management (RM) processes of vehicles and systems requires tools to facilitate collaboration among people in the supply and service chain. Currently, requirements management (RM) software uses model-driven, objected-oriented (OO) tools based on information authored and collected by people. Since the RM is dependant on the information input into it, the RM is limited. Therefore, these typical RM tools are inflexible and cannot autonomously recognize anomalies without intervention from people. Some RM tools are based on knowledge agents, giving it the ability to learn and recognize anomalies. Such RM tools are also inflexible.

In the requirements step, there are two classes of knowledge problems that determine the type of product and system to be analyzed, and then the tools and processes required for development, production, and service. These two classes of problems include “tame” and “wicked” problems. Most problems are tame and can be solved with a stage-gate, linear process and information-based tools. Developing the requirements for a system to manage wicked problems requires a spiral process and knowledge-based tools.

Wicked problems are composed of a linked set of issues and constraints, and do not have a definitive statement of the problem itself. The problem (and therefore the requirements for designing a solution) cannot be adequately understood until iterative prototypes representing solution candidates have been developed. Within the primary overall development process, which is linear, a secondary spiral process for iterative prototypes is required. The spiral process involves “rolling out” a portion of the software at a time while another portion is being developed. The software engineering community has recognized that a spiral process is essential for rapid, effective development.

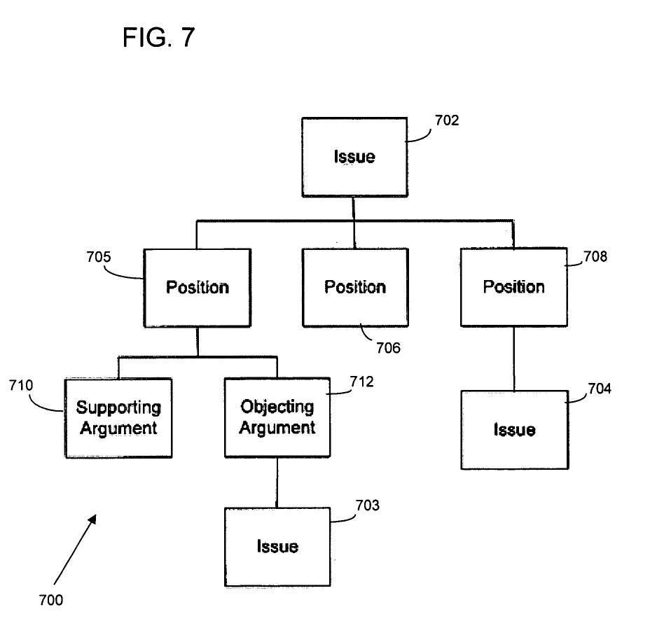

An example of a wicked problem is the design of a car and the diagnostics for the car. The “wicked” terminology was introduced by Horst Rittel in 1970. Rittel invented a technology called issue-based information systems (IBIS) to help solve this new class of problems. Wicked problems look very similar to ill-structured problems, but have many stakeholders whose views on the problem may vary. Wicked problems must be analyzed using a spiral, iterative process, and the ideas, such as requirements associated with the problem, have to be linked in a new paradigm 700, illustrated in FIG. 7.

Referring to FIG. 7, the three key IBIS entities are (1) issues 702, 703, 704, or questions, (2) positions 705, 706, 708, or ideas, that offer possible solutions or explanations of the issues, and (3) arguments 710, 712, or the pro's and con's. All three entities can be linked by relationships such as supports, objects-to, is—suggested—by, responds to, generalizes, specializes, replaces, and others. The visualization of IBIS becomes a graph or a network. IBIS builds a bridge between design and argumentation or the expressed dialog of ideas that forms the core of knowledge management.

IBIS is a graphical language with a grammar, or a form of argument mapping. Applying IBIS requires a skill similar to the design of experiments (DOE). Jeffrey Conklin (http://cognexus.org/idl7.htm) pioneered the application of graphical hypertext views for IBIS structures with the introduction of graphical IBIS or gIBIS. The strength of IBIS, according to Conklin, stems from three properties: (1) IBIS maps complex thinking into analytical structured diagrams, (2) IBIS exposes the questions that form the foundation of knowledge, and (3) IBIS diagrams are much easier to understand than other forms of information.

In the Compsim IBIS tool architecture, ideas can be specified in either the form of a text outline or a tree structure of nodes. Ideas of a given level can have priorities and weights to change the ordering of the display of ideas. Priorities can be easily edited in a variety of graphical ways. A unique decision making mechanism mimics human thinking with relative additions and subtractions for supporting negating arguments. The IBIS logic is captured as XML definitions and is used to build linked networks of knowledge-based agent networks. Compsim calls this agent structure knowledge enhanced electronic logic (KEEL). The agents execute an extended form of the IBIS logic.

The current field that contains IBIS is called computer-supported argument visualization (CSAV). Related fields that apply CSAV are computer-supported cooperative work (CSCW) and computer-mediated communication (CMC), which helped spawn the Internet. CMC tools include Microsoft's NetMeeting™ product.

Argument visualization is a key technology for defining the complex relationships found in requirements management, which is a subset of knowledge management (KM). One of the principles for KM is found in constructivist learning theory, which requires the negotiated construction of knowledge through collaborative dialog. The negotiation involves comparative testing of ideas. The corresponding dialog with visualization of ideas creates the tacit knowledge that comprises the largest part of knowledge as opposed to the explicit part of knowledge directly linked to information. Tacit knowledge is essential for shared understanding.

IBIS is a knowledge-based technology. IBIS tools for requirements management such as Compenium™ or QuestMap™ (trademarks of GDSS, Inc.) are distinctly different from object-oriented (OO) framework tools for RM such as Telelogics's Doors™ or IBM's Requisite-Pro™. Wicked problems cannot be easily defined such that all stakeholders agree on the problem or the issues to be solved. There are tradeoffs that cannot be easily expressed in OO framework with RM tools. IBIS allows dyadic, situated scenarios to define requirements. IBIS allows the requirements to be simulated. IBIS can sense those situations and determine which set of requirements is appropriate or whether the requirements even adequately apply to the situation.

In summary, current RM tools have limitations. OO RM tools enable traceability between requirements, design, and implementation during development, but not during the production or service deployment phases. OO RM tools are not knowledge-based and cannot easily handle ill-structured, wicked problems with multiple stakeholder views that conflict with different weighted priority ranking of those views expressed as the pro's and con's of argumentation. IBIS RM tools overcome most of those limitations but do not develop traceable requirements for a system design.

Both OO RM and IBIS RM tools recognize that the relationship between ideas as expressed in text alone is not clear without additional structure such as an outline with an associated hierarchy. Network structures such as those made possible by hypertext technology can be traced back to Vannevar Bush and his 1945 article As We May Think. In 1962, Douglas Englebart defined a framework for cognitive augmentation with tools in his report from the Stanford Research Institute, Augmenting Human Intellect: A Conceptual Framework. The result of Englebart's research and development work was the development of the modern windows, icon, mouse, and pointer (WIMPT) graphical user interface (GUI) and an early implementation of hypertext-based tools.

Round-trip engineering for OO, or model-driven software development, is a source code for implementation that is traceable back to elements of design and requirements. The round-trip is between requirements, design, and implementation as source code and then back to design and requirements. Since round-trip engineering currently occurs only during development and only within certain segments of the IDE, model anomalies that appear in the RTE after development cannot be traced back to root causes in requirements, design, or implementation. A segmented IDE might consist of four quadrants. These quadrants contain methods and tools for (1) enterprise applications in a system, (2) embedded software for the vehicles, (3) telematics for the vehicle, and (4) service systems for the vehicle.

Frequently, the OO model is defined using a unified modeling language (UML). UML is a third generation OO graphical modeling language. The system model has structural, behavioral, and functional aspects that interact with external users called actors as defined in use cases. A use case is a named capability of the system. System requirements typically fall into two categories: functional requirements and non-functional or Quality of Service (QoS) requirements.

Functional means what the system should do. QoS means how well or the performance attributes of the function. In common usage, functional can imply both functional and performance. The structural aspect defines the objects and object relations that may exist at run-time. Subsystems, packages, and components also define optional structural aspects. The behavioral aspect defines how the structural elements operate in the run-time system. UML provides state-charts (formal representation of finite-state-machines) and activity diagrams to specify actions and allowed sequencing. A common use of activity charts is specifying computational algorithms. Collections of structural elements work together over time as interactions. Interactions are defined in sequence or collaboration diagrams.

The requirements of a system consisting of functional and QoS aspects are captured typically as either one or both of two ways: (1) a model is use cases with detailed requirements defined in state charts and interaction diagrams, or (2) specifications as text with or without formal diagrams such as sequence diagrams that attempt to define all possible scenarios of system behavior.

Round-trip engineering traces OO requirements through OO design into an OO implementation that includes the OO source code for software. This round-trip occurs only in certain segments of the IDE, which are OO IDE segments, and only during development. Currently, there is no round-trip traceability between an RTE and an IDE during development, production, and service. Round-trip engineering has been extended to use a meta-model rather than require obtrusive source code markers, but extended round-trip engineering still occurs only within certain segments of the IDE during development.

Model-based diagnostics is a state-of-the-art method for fault isolation, which is a process for identifying a faulty component or components of a vehicle and a system that is not operating properly in compliance with operating parameters specified as part of the vehicle and system's implementation model. Model-based diagnostics suffers from the limitations of assuming that all the operating scenarios of the system and all of the potential faults of the system are a priori known and can be described. The operating scenarios of the system include all expected faults.

If an adequate amount of observable information from the vehicle is available at run-time, model-based diagnostics can determine the root cause for previously known and expected failure modes predicted by an expanded model that includes both normal and failure modes. The expanded model is used to simulate and record the behavior resulting from all possible single component failures, then combinations of multiple component failures. When failure behavior is observed, a sequence of pre-determined experiments can be performed to determine the root cause.

Faults in the vehicle and system's requirements or design and implementation models are mainly detected after development by users who may complain and have their complaints analyzed by service technicians and then possibly by engineers. Situations that led to the complaints are frequently not easily identified and reproducible. The process of fault isolation or root cause determination generally begins at detection of abnormal system behavior and, as described herein, attempts to identify the defective and improperly operating component or components. These components perform some collection of functions in the system. The components are frequently designed to be field replaceable hardware units that may contain software. However, the failure model assumed in current practice considers functional failure modes of the replaceable component and may not determine whether the failure inside the component or components is a hardware or a software failure. If the failure is in software, then the failure may have occurred at the requirements, design, or implementation level. Replacing the hardware component or components may not repair the problem, because the user of the system cannot readily examine the software operation.

In one example embodiment, an improved method and system of detecting lifecycle failures in vehicle functional subsystems, that are caused either by hardware failures or by software anomalies in requirements, design, or implementation and tracing the failure back to the root cause in the model, is contemplated. For tracing, the method uses a new capability for lifecycle round-trip engineering that links diagnostic agents in the RTE with a dyadic model in the IDE for managing the development and maintenance of vehicle functions and the corresponding diagnostics. The dyadic model in the IDE is managed by linked dyadic tools that develop functions and corresponding diagnostics at each level of the spiral development “V” process (which will be described in more detail later): requirements, design and implementation. The lifecycle diagnostic method, which links the IDE and RTE, can be applied during development, production, and service of the vehicle RTE.

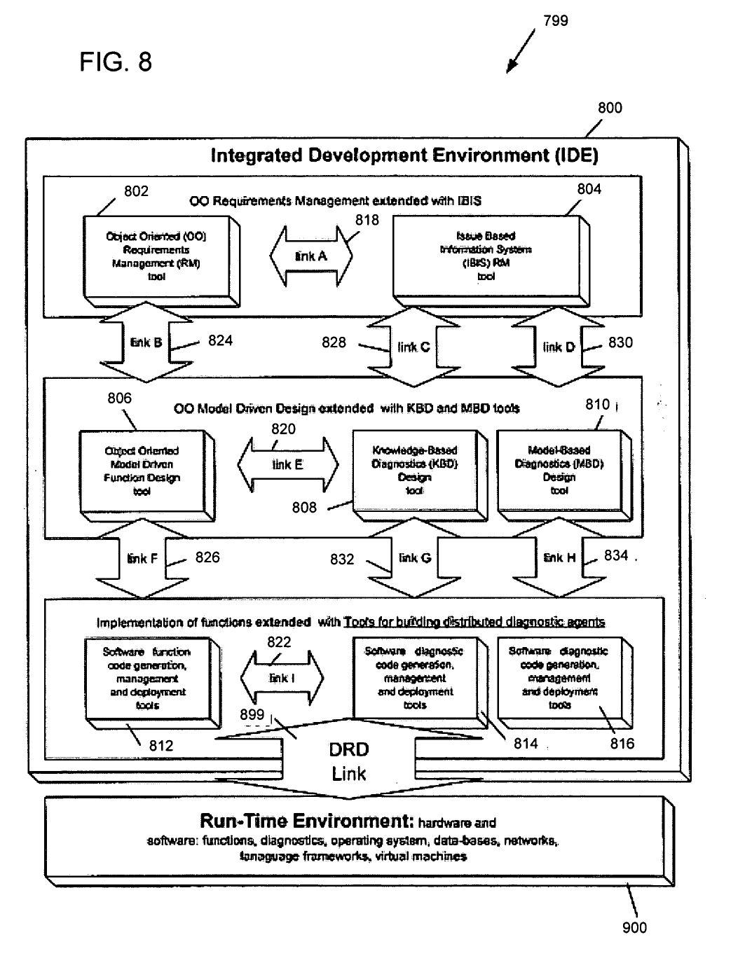

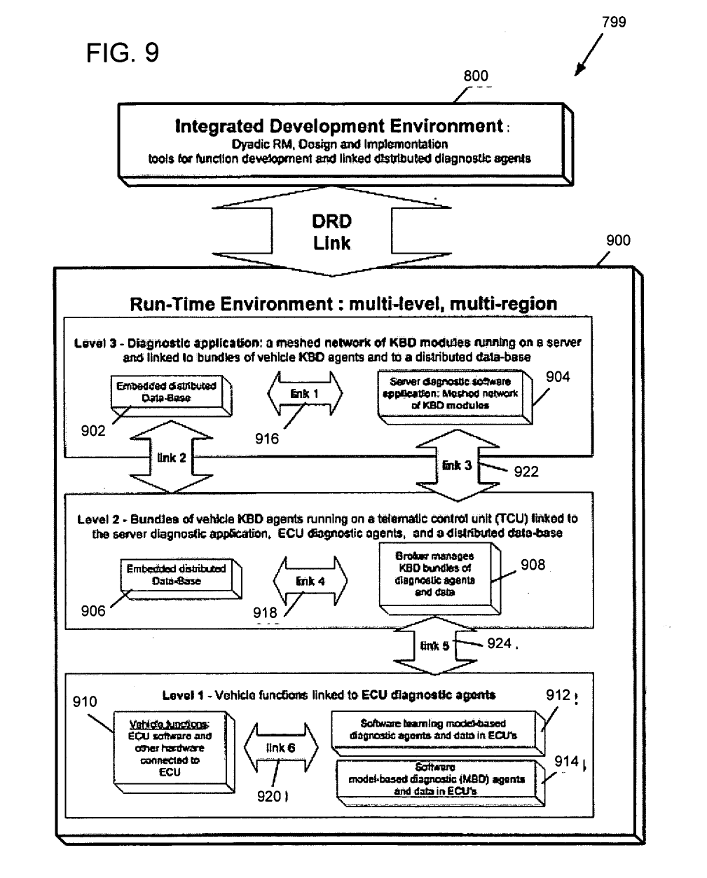

Referring to FIGS. 8 and 9, a learning model-based lifecycle diagnostic system 799 is illustrated. Preferably, the system 799 includes an IDE 800 and a RTE 900 linked by a DRD link 799. FIG. 8 is a system diagram, according to one example embodiment, for a lifecycle diagnostic method for the development of vehicle functions and corresponding diagnostics in the IDE 800 and the deployment of diagnostics in an RTE 900 to service vehicles. The diagram illustrates how the lifecycle method links development tools together in the IDE 800 with linkages. The IDE 800 in the lifecycle method contains development tools and processes to develop vehicle functions and a corresponding diagnostic application consisting of a set of integrated and linked diagnostic agents for deployment in the RTE 900. The IDE 800 and the RTE 900 are linked through a DRD link 799 and corresponding processes. The DRD 799 can include a database, which can be a distributed database.

FIG. 9 is a system diagram, according to one example embodiment, for a lifecycle diagnostic method for the development of diagnostics in an IDE 800 and the deployment of diagnostics in a RTE 900 to service vehicles. The diagram illustrates how the lifecycle method links diagnostic agents together in the RTE 900 with linkages. The RTE 900 in the lifecycle method contains and operates the diagnostic application deployed as a three level system consisting of diagnostic agents, running on servers, TCUs, or equivalent modules that plug into vehicles, and ECU's. Production Service tools interface to the vehicle and are part of the RTE 900. The RTE 900 is linked back to the IDE 800 through the DRD link 899 and corresponding processes.

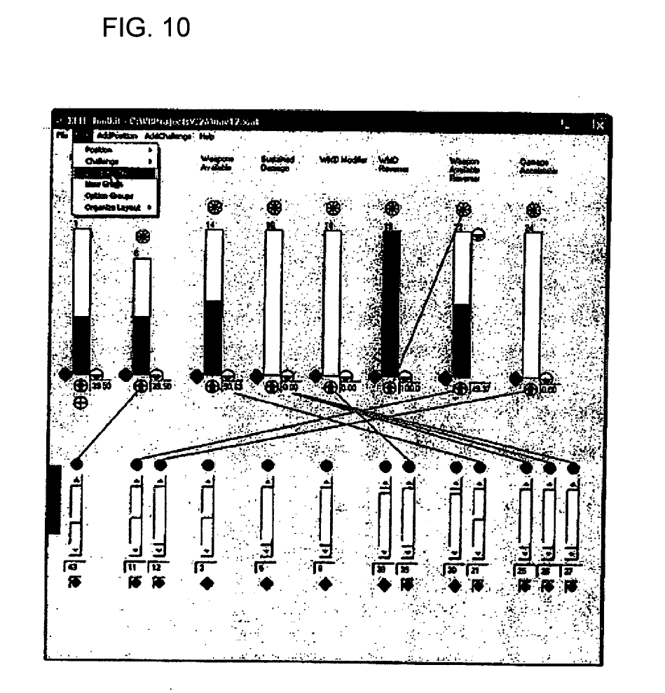

As shown in FIG. 10, an IDE tool such as the Compsim KEEL toolkit can be driven by the data returned in the DRD link 799, FIG. 8, to simulate and test the design model and analyze the failure mode. The data shown below is an example of the input schema defined in XML by the IDE 800, FIG. 8; the schema is stored in the DRD link 899:

− <Schema name=“KEELDataSchemaxml” xmlns=“urn:schemas-
microsoft-com:xml-data” xmlns:dt=“urn:schemas-microsoft-
com:datatypes”>
<ElementType name=“Index” dt:type=“ui2” />
<ElementType name=“Value” dt:type=“float” />
− <ElementType name=“InDat” content=“eltOnly” model=“closed”>
<element type=“Index” minOccurs=“1” />
<element type=“Value” minOccurs=“1” />
</ElementType>
<ElementType name=“ProjectTitle” content=“textOnly” model=“closed”
dt:type=“string” />
− <ElementType name=“Report” content=“eltOnly” model=“closed”>
<element type=“ProjectTitle” minOccurs=“1” />
<element type=“InDat” minOccurs=“0” maxOccurs=“*” />
</ElementType>
</Schema>

The DRD link 899 eliminates the need for the RTE agents 600 to know how to communicate with the tools in the IDE 800. The system 799 creates the proper linkages between the IDE 800 and the RTE 900 using only the information in the DRD link 899. An example of the data returning from the RTE 900 to the IDE 800 is shown below:

<?xml version=“1.0” ?>
− <Report xmlns=“x-schema:KEELDataSchemaxml.xml”>
<ProjectTitle>UAV1</ProjectTitle>
− <InDat>
<Index>0</Index>
<Value>100</Value>
</InDat>
− <InDat>
<Index>1</Index>
<Value>22</Value>
</InDat>
− <InDat>
<Index>2</Index>
<Value>82</Value>
</InDat>
− <InDat>
<Index>3</Index>
<Value>60</Value>
</InDat>
− <InDat>
<Index>4</Index>
<Value>64</Value>
</InDat>
− <InDat>
</Report>

Referring back to FIG. 8, preferably, the IDE 800 has three levels of development activity for users of the system 799 with corresponding tools and processes. These three levels are requirements management, design, and implementation. The system 799 creates a linked dyadic tool pair for functions and diagnostics at each level in the IDE 800.

At the top of FIG. 8 is the activity called requirements management. Typical model-driven, object-oriented (OO) development tools for requirements management (RM) are IBM/Rational Requisite Pro™ and Telelogic DOORS™. The lifecycle method creates a new dyadic capability for RM by augmenting existing OO RM tools with an issue-based information (IBIS) tool such as the Compsim Management Tool™ (CMT).

The IDE 800 includes a first RM 802, a second RM 804, a first design tool 806, a second design tool 808, a third design tool 810, a first deployment tool 812, a second deployment tool 814, and a third deployment tool 816. Preferably, the first RM 802 is implemented as OO RM Tool, and the second RM 804 is implemented as an IBIS RM Tool. The first design tool 806 is implemented as an OO model-driven function design tool, such as IBM/Rational Rose™, iLogix's Rhapsody™, the MathWorks's Simulink™ or ETAS's ASCET/SD™.

The second design tool 808 is implemented as a knowledge-based diagnostics design tool. The third design tool 810 is implemented as a model-based diagnostics design tool. The second design tool 808 and the third design tool 810 comprise a diagnostic builder tool suite that contains both knowledge-based diagnostic design tools and model-based diagnostic design tools. These tools enable the user of the system 799 to develop run-time diagnostic agents for the corresponding designed vehicle functions. The diagnostic agents are intended to run on the three levels of the RTE 900, FIG. 9. The diagnostic builder suite specifies the targeted level of the RTE 900 for each diagnostic agent and builds the links shown in FIG. 9 between the agents in the RTE 900. An example of a knowledge-based agent development tool is Compsim's KEEL™. An example of a model-based agent development tools is R.O.S.E.'s Rodon™.

The first deployment tool 812 is implemented as a software function code generation, management, and deployment tools such as ASCET/SD™. The second deployment tool 814 is implemented as a software diagnostic code generation, management, and deployment tool. And, the third deployment tool 816 is implemented as a software diagnostic code generation, management, and deployment tool.

The first RM 802 is linked to the second RM 804 via link 818. The link 818 is any standard communication link known in the art. The link 818 is a bi-directional, integrated link that enables capturing the knowledge, assumption, and decision logic behind the requirements captured in the first RM 802. Preferably, the system 799 implements link 818 by passing unique XML function identifier descriptors (FIDs-RM) for objects in the first RM 802 to the second RM 804 and by building a data relationship with XML diagnostic identifier descriptors (DIDs-RM). The dyadic relationship for link 818 is stored in the DRD link 899. By windowing the second RM 804 into the graphic user interface of the first RM 802, the system 799 enables the user to define the decision logic behind the requirement being captured as objects in the first RM 802, such as a use case. The logic in the second RM 804, corresponding to the object in the first RM 802, is defined as unique XML diagnostic identifier descriptors (DIDs).

The first design tool 806 is linked to the second and third design tools 808, 810 via link 820. Link 820 bi-directionally passes unique XML defined function identifier descriptors for design (-D) and diagnostic identifier descriptors for design (-D) and integrates the graphical user interface of the separate tools at the design level.

The first deployment tool 812, or functional module, is linked to the second and third deployment tools 814, 816, or diagnostic agents, via link 822. Link 822 bi-directionally passes unique XML defined function identifier descriptors for implementation (-I) and diagnostic identifier descriptors (-I) and integrates the graphic user interface of the implementation tools. Link 822 is implemented by defining the ECU memory locations and data types for the information corresponding to vehicle modules. ASAM MCD™ with XML is an example of such a link. Tools, such as ETAS's ASCET/SD™ and INCA™, can be used to implement link 822.

The first RM 802 is also linked to the first design tool 806 via link 824. The first design tool 806 is also linked to the first deployment tool 812 via link 826 for implementation. Links 824, 826 enable what is called round-trip engineering for functions in the development environment. Objects corresponding to requirements can be traced through design to the source code in implementation and back up to design and requirements.

Likewise, the second RM tool 804 is linked to the second and third design tools 808, 810 via links 828, 830, respectively. The second and third design tools 808, 810 are linked to the second and third deployment tools 814, 816 via links 832, 834, respectively. Links 832, 834 enable round-trip engineering for diagnostics in the development environment. XML defined design objects for diagnostics are linked to source code for diagnostics.

The system 799 integrates model-based diagnostic design tools, such as R.O.S.E's Rodon™, that generate source code with tools, such as ASCET/SD™, to generate executable code on a real-time operating system for implementation on the RTE 900, FIG. 9.

Referring to FIG. 9, the RTE 900 has three levels of software and hardware. Using the tools in the IDE 800, the DRD Link 899, and processes, the system 799 enables the building of a diagnostic application as a collection of linked diagnostic agents that run on the three levels. Some of the agents can be downloaded onto level 2 using OSGi™.

The RTE 900 includes a first database 902, a server application 904, a second database 906, a broker 908, an electronic control unit (ECU) 910, learning agents 912, and agents 912, 914. Preferably, the first database 902 is an embedded distributed database known in the art. The server application 904 is a server diagnostic software application and meshed network of KBD modules. The second database 906 is an embedded distributed database. The broker 908 manages KBD bundles of diagnostic agents and data. The ECU 910 includes software and other hardware connected to the ECU. The learning agents 912 include software learning model-based diagnostic agents and data in ECU's. The agents 914 include software model-based diagnostic (MBD) agents and data in ECU's.

The first database 902 is linked to the server application 904 via link 916. The second database 906 is linked to the broker 908 via link 918. The ECU 910 is linked to the learning agents 912 and the agents 914 via link 920. The server application 904 is also linked to the broker 908 via link 922. The broker 908 is linked to the learning agents 912 and agents 914 via link 924.

The IDE 800 and RTE 900 are linked via link 899. Link 899 is a Development, Run-time, Development (DRD) link. Preferably, the DRD link 899 is implemented using a telecommunications and operations infrastructure (TOI) containing combinations of a distributed database and software interprocess communication (IPC) mechanisms. In the DRD link 899, the information sent through the database or IPC mechanisms are defined by XML schemas and contain both IDE 800 and RTE 900 data. The XML schema could be sent in messages or optionally be used to configure a distributed database.

During development, new diagnostic tools in the IDE 800 are used to guide users to follow a spiral “V” process “down” and “up” the “V” to build IDE model linkages (as is described in more detail below) between functions uniquely identified with function identifier descriptors (FIDs) and corresponding diagnostics uniquely identified with diagnostic identifier descriptors (DIDs) at the levels of requirements, design, and implementation. The IDE dyadic (function-diagnostic) model linkages with FIDs and DIDs are stored in the DRD link 899 database.

Consequently as the method follows the spiral “V” process over iterative prototyping cycles during development, a new dyadic system model is built in the IDE 800 and the DRD link database 899. An RTE 900 is also built for the vehicle. The RTE 900 contains a three-tier level of diagnostic agents that are linked together into an integrated diagnostic application architecture (DAA) and linked to the vehicle functions including software with corresponding calibration parameters in ECU's.

The three-tier RTE 900 includes managers on the servers 904 and brokers 908 on the TCUs for dynamically deploying the agents 912, 914 onto vehicles such as downloading agents to a vehicle's TCU or a vehicle service module (VSM).

In the RTE 900, run-time linkages or run-time binding between software objects is performed by the agent manager and brokers using the IDE defined XML schemas and data such as the FIDs and DIDs contained in the DRD link 899. This enables linking agents together and linking agents with functions.

An example of the linking is connecting a diagnostic agent with a calibration parameter in an engine ECU. In an IDE 800 using UML, these connections might also include ports and protocols. In an IDE 800 and a RTE 900 complying with the Association for Standardization of Automation and Measurement (ASAM), additional access methods for measurement, calibration and diagnosis (MCD) that relate to ECU's in vehicles would be defined. These access methods would still be contained in the DRD link 899 and represented as XML schemas with embedded data.

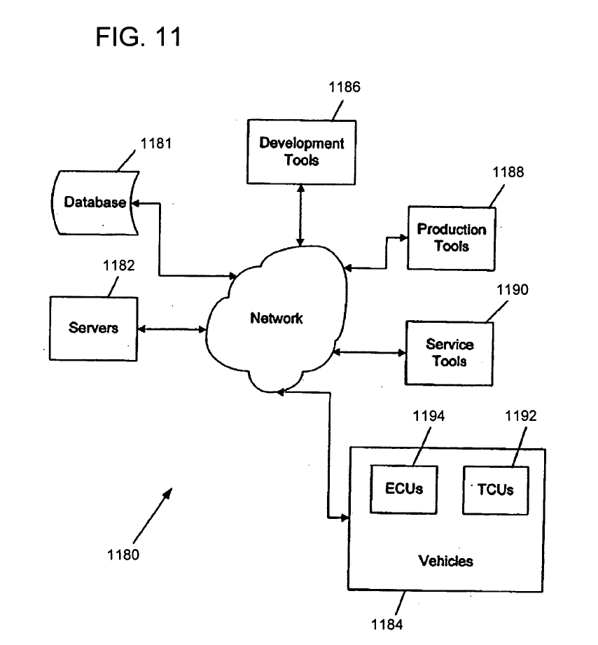

Referring to FIG. 11, a lifecycle diagnostic method manages vehicles in a distributed system 1180. The distributed system include a database, 1181, servers 1182, vehicles 1184, tools for development, production and service, 1186, 1188, 1190 and modules inside the vehicle such as TCUs 1192 and ECUs 1194. Preferably, the architecture that the method uses to define the system is the ISO Open System Interconnection (OSI) seven layer reference model. The layers are application, presentation, session, transport, network, data link, and physical. The DAA comprises the top three layers of the seven layer “stack” for a node, and the TOI comprises the bottom four layers of the stack.

Root cause tracing occurs with lifecycle round-trip engineering that links the detected failures in the vehicle RTE 900, FIG. 9, with the elements of the model in the IDE 800, FIG. 8. The linkage is implemented by using the IDE 800 linkages stored in the database. By tracing the linkages built with tools in an IDE 800, the candidates for root cause in requirements, design, and implementation can be determined.

A spiral lifecycle process is triggered by the likely detection of failures by cooperative, autonomous diagnostic agents in the vehicle RTE 900, FIG. 9. The agents would apply a range of algorithms and technologies that can be classified in several categories: model-based diagnostics (MBD), learning model-based diagnostics (LMBD) or knowledge based diagnostics (KBD). Current OBD diagnostic agents use MBD that frequently applies exponential moving averages, which are first order Kalman filters, to design acceptable Type 1 and Type 2 statistical error profiles.

The trigger can be assisted by service tools connected to the vehicle RTE 900, FIG. 9. The trigger sends information through messages or a distributed database to the vehicle's diagnostic application running on one or more servers. The messages or database transactions from the vehicle to the server(s) are created by the vehicle's TCU after being fed information from a combination of MBD and LMBD agents running in ECU's and a combination of MBD, LMBD, and KBD agents running in the TCU.

In a possible embodiment, LMBD agents can apply time-frequency based performance assessment technology for anomaly detection and fault isolation. Time-frequency analysis (TFA) based performance assessment provides a tool for managing a combined time-frequency representation of a signal or a set of signals that represent the normal behavior of a system into a model of that system. The behavior can vary over time and frequency. TFA is a method for detecting both slow degradation and abrupt failures.

Newly developed TFA signal representation methods can identify the behavior of a system's signature in ways that are difficult or impossible using time-series or spectral analysis. Optimal design methods for TFA include the Reduced Interference Distribution or RID. RID charts of time frequency distributions achieves the goal of providing high resolution time-frequency representations with desirable mathematical properties such as time, frequency, and scale shift covariance, time and frequency marginal property, group delay and constant frequency properties and suppression of cross-terms (Cohen). Learning MBD agents built with RID TFA technology exhibit many desirable properties such as very rapid identification of failures without using a model, with minimal processing and with engineered statistical confidence in the detection.

LMBD and other diagnostic agents can alternately apply local linear models in combination with growing structure competitive learning to detect system anomalies while minimizing error, even in extremely nonlinear systems. Local linear models provide an easily-computable, close estimation that represents the normal behavior of a system. Local linear model usage avoids complicated, computationally-intensive analysis, and can therefore easily be adapted to real-time applications.

Consider a general dynamic system to be tested whose input-output relationship is described by the following differential equations, in which u represents system inputs, y represents outputs, x represents state variables, and denotes the matrix transposition operator:

U=[U1, U2, . . . ,Up]T x(k+1)=f (x(k), u(k)) where: Y=TYiIY2 y(k)=h(x(k),u(k)) w=[Y . . . ,AE]^{T}

If the tested system inputs and outputs are observable, and the state variables can be reconstructed from system observation, then the system can be described by a nonlinear autoregressive with exogenous inputs (NARX) model which takes the following form:

$$y ( k + 1 ) {\sum }_{m = 1}^{M} {v}_{m} ( s ( k ) ) {F}_{m} ( s ( k ) )$$

In further embodiments, additional models can be used, including a Takagi-Sugeno method, auto-regressive with exogenous inputs (ARX) and a combination of these models.

In these systems, the problem of nonlinear dynamic modeling reduces to the problem of approximating the functional relationship of Fₘ(s(k)) in the above equation by using a set of local models focused on a small region in the space occupied by the system spanned by vectors of the form:
s(k)=[y(k)^{T}, . . . ,y(k−nᵤ+1)^{T}, u(k−n_{d}), . . . , u(k−n_{d}−n_{b}+1)^{y}]^{T}

If the model structure is such that it is linear with respect to its parameters, then the model parameters can be estimated by recursively non-linearly minimizing in the least squares sense the modeling errors in the training set. One example model useful in this context is a local model, in particular a local linear model. Local linear models are a good choice for use because of their limited computational demands.

Diagnostic agents can use local models to detect anomalous system behavior by setting a threshold on residual error. In one possible embodiment, a local linear model can be used. The threshold on residual error is set with respect to each operational region in order to avoid detection of anomalies in regions sparsely populated during the training process, which would result in high missed detection and false alarm rates. By splitting the entire operational space of the tested system into sufficiently small regions at places where nonlinearity is high, a linear model provides an acceptable and easily computable estimate of actual system operation.

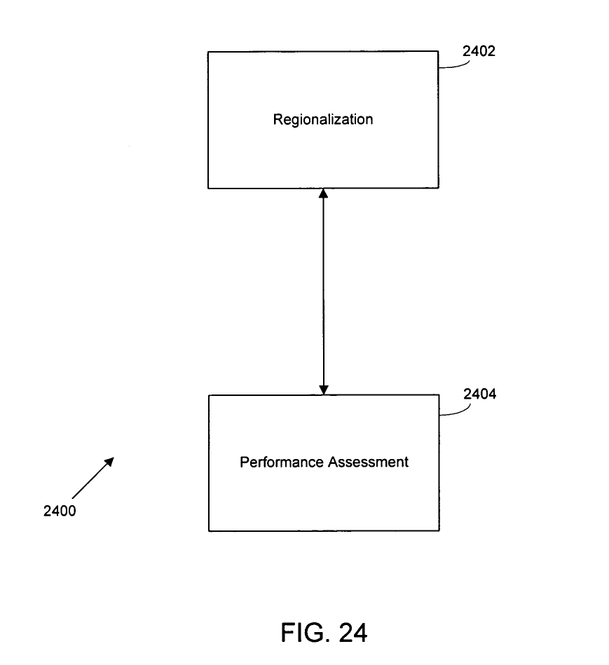

Either of the preceding methods for detecting anomalies, using time-frequency analysis or local linear modeling, are suitable for usage consistent with the present disclosure, either for initial detection of anomalies or for comparison of error-prone systems to identify and root-cause newly encountered anomalies. Use of these techniques is discussed in greater depth in conjunction with FIGS. 24-37.

Referring back to FIGS. 8 and 9, a possible embodiment of a learning model-based lifecycle diagnostics system 799 includes an IDE 800, linkages within the IDE between IDE tools, an RTE 900, linkages within the RTE 900, and a DRD link 899. These linkages, operating with agents and tools in the RTE 900 and tools in the IDE 800, enable the system to trace failures, or anomalies, detected in the RTE back to the root cause as model anomalies in the IDE.

To trace model failures back from the RTE 900 to the IDE 800, the method implements round-trip engineering between diagnostic agents in the RTE 900 and diagnostics linked to the corresponding vehicle functions in the IDE 800. The functions are represented as a model with objects. Because the agents, processes, tools, and linkages operate together in a spiral process to learn model anomalies over a vehicle's lifecycle, the method is called lifecycle learning-model based diagnostics.

An IDE 800 is an integral part of the lifecycle method in addition to a RTE 900 for software on the vehicle and software that supports the production and service of the vehicle. Service of the vehicle includes service operations at dealers and a telematic service such as OnStar™. Preferably, the RTE 900 includes fleets of vehicles, the electronic control units (ECU's), networks, sensors, actuators and user interface devices such as speedometers on dashboards on individual vehicles, and a telecommunications and operations infrastructure (TOI) that includes computers such as distributed servers, communication networks such as cellular and wireless LAN's such as WIFI, and tools such as diagnostic scan tools generally found at OEM dealerships and independent aftermarket (IAM) repair shops.

Preferably, the IDE 800 is a computing laboratory and experimental driving environment with a collection of development tools for developing and maintaining vehicle functions such as power train electronics, including the ECU's, sensors, and actuators for an engine and transmission, body electronics, such as the ECU's, sensors, and actuators for lighting systems, and chassis electronics, such as the ECU's, sensors, and actuators for anti-lock braking systems (ABS). The vehicle functions are implemented in systems such as power train and corresponding subsystems, such as engine cooling. These systems and subsystems include both hardware and software. The IDE 800 is also used to develop the enterprise application software (alternately called the information technology or IT software) to support vehicle production and service operations.

The software that implements vehicle functions generally runs on electronic control units (ECU's) and an optional telematic control unit (TCU) residing on the vehicle. The application software runs on computers such as servers and PC's and for service tools such as diagnostic scan tools. The development of vehicle diagnostic software for service operations is commonly called authoring. The diagnostic software on the vehicle is called on-board diagnostics (OBD).

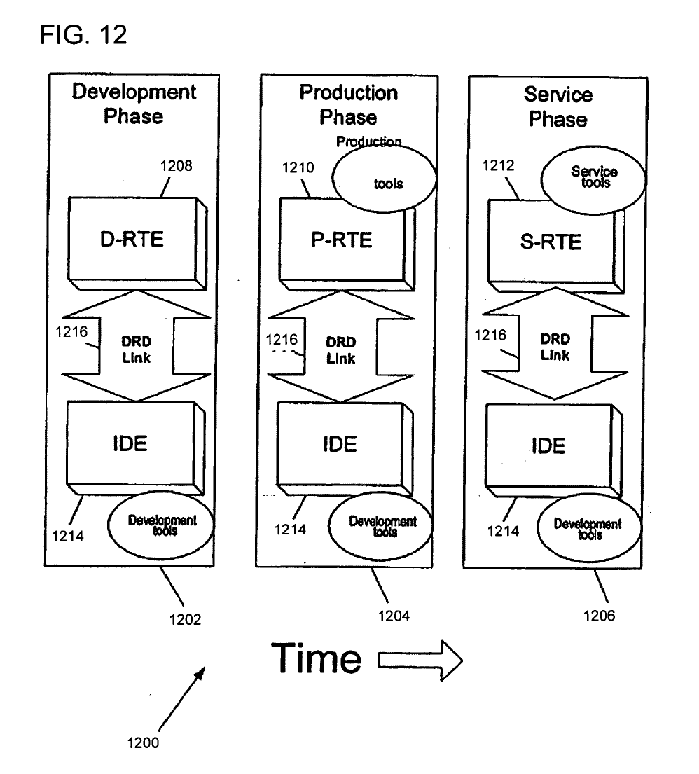

The processes used in the methods of the IDE 800, FIG. 8, are illustrated in FIGS. 12-21. As these processes are followed, the linked tools in the IDE 800 build information in the DRD 899 to link the diagnostic application and agents in the RTE 900 with the IDE 800. Those agents read the DRD 899 to find FIDs linked with DIDs.

FIG. 12 is a process diagram illustrating a vehicle product development lifecycle 1200, according to an exemplary embodiment of the present disclosure. The product development process for a specific model year of a vehicle over its lifecycle is conceptually divided into three phases including a development phase 1202, a production phase 1204, and a service phase 1206. Development, production and service activities require the management of large amounts of software. Software creates a major part of the vehicle function and a major part of a business information system to support the vehicle's lifecycle.

Development of a production and service capability including the tools for production and service occurs during the development phase 1202. Capability is defined as people with knowledge, tools, technology, and processes. There is an associated architecture that represents the structure of the capability, including a business information system, represented by tools and technology. There is a large amount of software in the business system. The associated architecture also includes the structure of the vehicle, including its subsystems, which include its on-board information system. There is also a board diagnostic (OBD) system in the vehicle. This OBD system includes a large amount of software. Part of the OBD system is required by government regulations to indirectly monitor the vehicle's emissions by monitoring the operation of the vehicle's emission control systems. Typically, there is almost as much diagnostic software in a vehicle's power train ECUs as there is control software.

The information system on the vehicle typically includes many electronic control units (ECUs). Vehicles typically have fifty or more ECUs. These ECUs contain a large amount of software. The architecture of a vehicle, and its production and service systems, are completely defined during development. The development phase 1202 typically begins with a large part of the architecture previously determined in a research and development (R&D) phase (not shown) that precedes the development phase 1202. The architectural model for a vehicle model is typically derived from a platform model, which includes power train, chassis body, and other subsystem components.

The product development process enables development, production, and service of both the vehicle and the business system as a product. The process operates with the corresponding business system that supports the vehicle during development, production, and service.

The product and the business system are supported by the process, which is part of an organizational capability. The capability has an associated architecture. The architecture relates to both the vehicle and the business system. The capability includes internal and external (outsourced) services with people and their knowledge, applications, tools, platforms, components, and technology. The capability supports the vehicle as a product and the business system in the supply and service chains. These chains support the original equipment manufacturer (OEM) and the vehicle as a product over the lifecycle.

The lifecycle for a vehicle typically lasts more than ten years. The development phase 1202 is about two to three years, followed by several years of the production phase 1204 for several model years. The production phase 1204 is followed by many years of the service phase 1206. The initial part of the service phase 1206 for a specific vehicle typically includes an original equipment service (OES) warranty period of three or more years that is followed by a service period that includes the independent aftermarket (IAM).

These development, production, and service phases 1202, 1204, 1206 are illustrated as following each other sequentially over time, but there is overlap that will be illustrated in subsequent figures. The production phase 1204 begins with the start of production (SOP). The service phase 1206 begins with the first customer shipment (FCS) of a vehicle. As many vehicles are produced for a model year, the production and service phases 1204, 1206 overlap.

In each phase 1202, 1204, 1206 of the process, there is an RTE and an IDE. The RTE is specific to a phase. D-RTE 1208 represents a development-RTE; P-RTE 1210 represents a production RTE; and S-RTE 1212 represents a service RTE. A manufacturing plant with production tools would be included in the P-RTE 910. An OEM dealer's service department with service tools would be included in the S-RTE 1212. A single IDE 1214 with development tools is common to all phases and linked to each specific RTE 1208, 1210, 1212. The IDE 1214 would typically be applied in the supply and service chains, and in the OEM and its business partners. The specific RTEs 1208, 1210, 1212 are connected to the IDE 1214 through a DRD Link 1216.

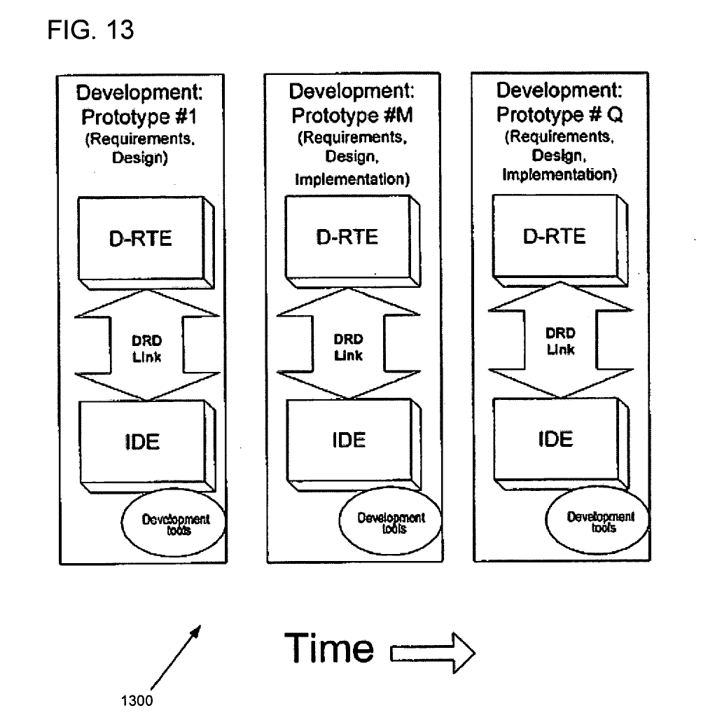

FIG. 13 is a process diagram illustrating the spiral lifecycle process 1300 used during the development phase 1202, FIG. 12, of the lifecycle to produce prototype cycles, according to an exemplary embodiment of the present disclosure.

The development phase 1202, FIG. 12, of the product development process is used to develop prototypes with a spiral sub process 1300. The sub process 1100 fits inside the development phase 1202. The vehicle model, and its supporting business system to be developed, consists of components in the categories of requirements, design, and implementation. Development typically begins with an activity to determine and specify some parts of the requirements model for the vehicle and its supporting business system, and then development proceeds to determine and specify some part of the design model for the vehicle and its supporting business system, which includes the RTE with its development, production, and service tools.

Development tools typically support simulation of design models, which enable testing to occur without fully implemented vehicles and supporting systems. Development tools with simulation and testing capabilities such as hardware in the loop (HIL) or software in the loop (SIL) are used to permit incremental development of subsystems before a completed vehicle is available. As development proceeds, some part of an implementation model can be determined and specified. The spiral process is used to incrementally complete parts of requirements, design, and implementation. The spiral process permits repeated forward sequences such as implementation determination and specification that follows design or reverse sequences such as requirements development that follow either design or implementation. Modern software engineering and corresponding tools encourages use of a spiral process during development to speed development, improve quality, and lower development cost.

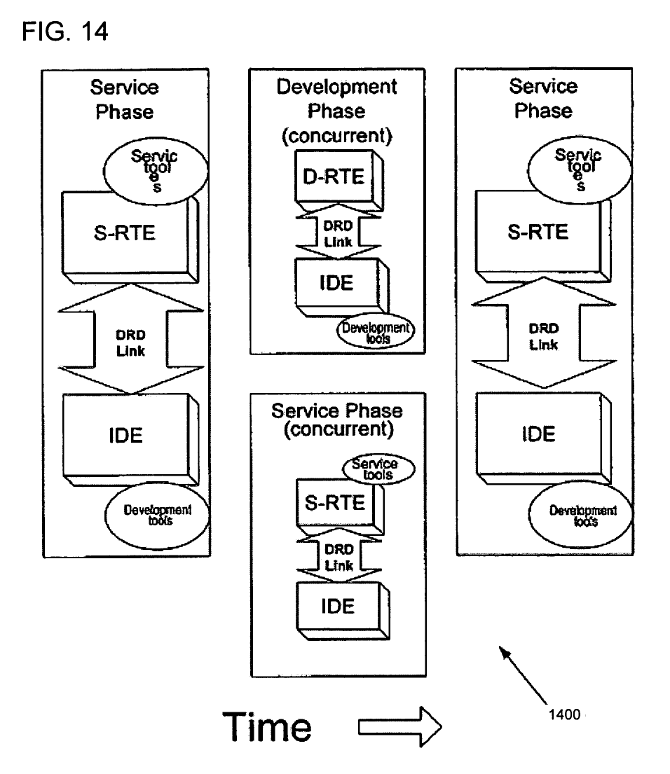

FIG. 14 is a process diagram illustrating the spiral lifecycle process 1400, with periods of concurrent development and service operations, according to an exemplary embodiment of the present disclosure.

The Lifecycle Spiral Process 1400 is required because during the service phase of the vehicle's lifecycle, faults and anomalies will be encountered. Faults are failures that have been previously analyzed and are predicted from a failure mode model. A procedure for determining root cause is probably known and can be effectively applied. Faults can typically be corrected in the field by repair procedures that include swapping or replacing parts.

Anomalies are failures that have not been previously analyzed and are not predicted from a failure mode model. A large part of the anomalies will have root causes in model anomalies, such as software bugs. Model anomalies will be found in the implementation of the vehicle and/or its supporting business system. The correction of these anomalies must be performed by returning to a development phase. The development phase operates concurrently with service operations as shown.

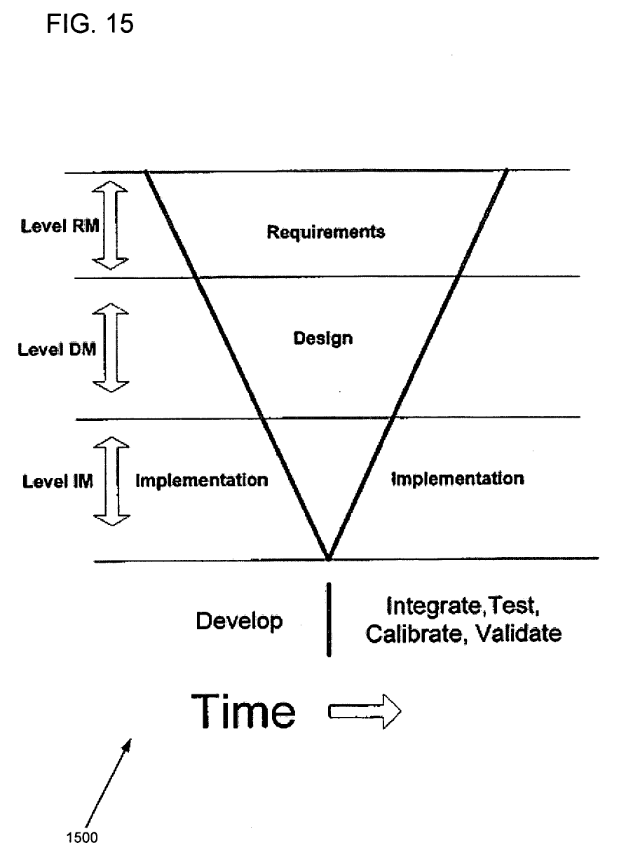

FIG. 15 is a process diagram illustrating the vehicle development phase containing prototype cycles 1500 as conceptual “V” cycles, according to an exemplary embodiment of the present disclosure.

The Development Phase 1202, FIG. 12, includes prototype cycles 1500 that follow the shape of a “V”. The “V” begins with the development of some parts of a vehicle model and business system as requirements, then optionally proceeds to development of parts of the design model and then optionally to development of parts of the implementation model. At the bottom of the “V”, the focus of development activity then shifts to integration, testing, calibration, and validation of the parts of the model that have been developed.

The “down cycle” is on the left and the “up cycle” is on the right side of the diagram. Horizontally across the “V” is a corresponding part of the model to be integrated, tested, calibrated, or validated. After being partially developed, components of requirements can be integrated, tested, and validated through methods like simulation. An early prototype “V” cycle might only include development and testing of requirements. After some parts of the design or implementation model have been developed, that part of the model can be integrated, tested, and validated with the previous parts of the model for the vehicle and business system. Each prototype cycle develops, integrates, tests, and validates more parts of the model, with components that include requirements, design, and implementation.

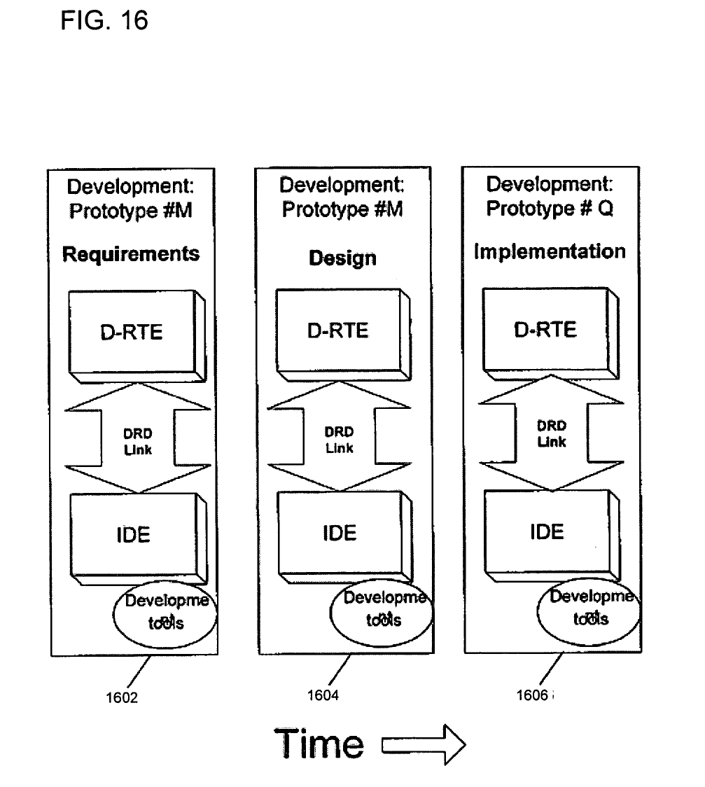

FIG. 16 is a process diagram illustrating how the lifecycle method progresses using the spiral process through requirements, design, and implementation, according to an exemplary embodiment of the present disclosure.

The development phase 1202, FIG. 12, progresses through prototyping cycles 1602, 1604, 1606. Each cycle initially moves through a “down cycle” of the “V” cycle that includes the development of the model in terms of the attributes of requirements, then design, and finally implementation. Early “down cycles” need only develop requirements before entering an “up cycle” to begin testing and validating the requirements. Most prototyping cycles in the development phase will include the development of the model in terms of the attributes of requirements, design, and implementation in the “down cycle”.

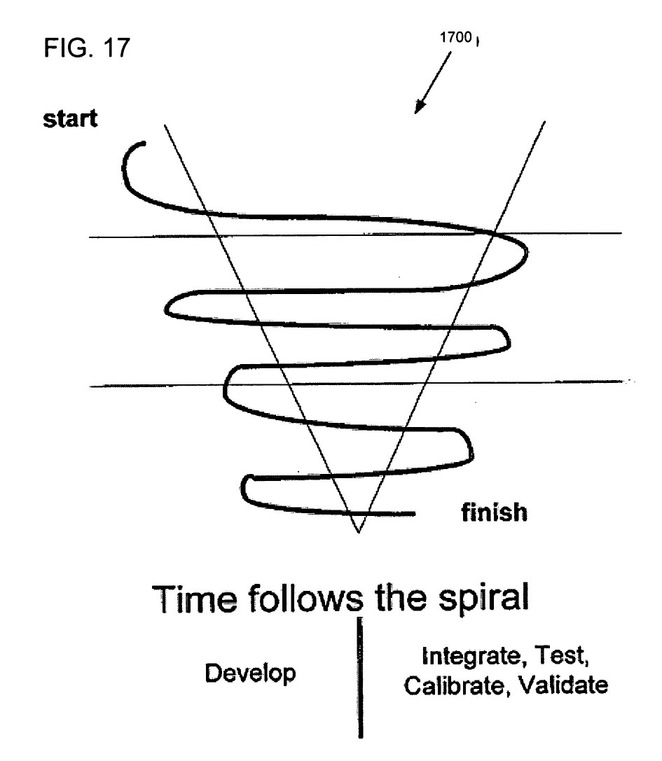

FIG. 17 is a process diagram illustrating how the lifecycle method applies a spiral sub process, according to an exemplary embodiment of the present disclosure.

The development phase 1202, FIG. 12, includes prototype cycles 1700. The cycles 1700 use a spiral process to move through the “V” initially in a “down cycle” as illustrated. With the spiral process, parts of the requirements attributes of the prototype model are developed and then tested, followed by parts of the design being developed and then tested, and then parts of the implementation attributes are developed and then tested.

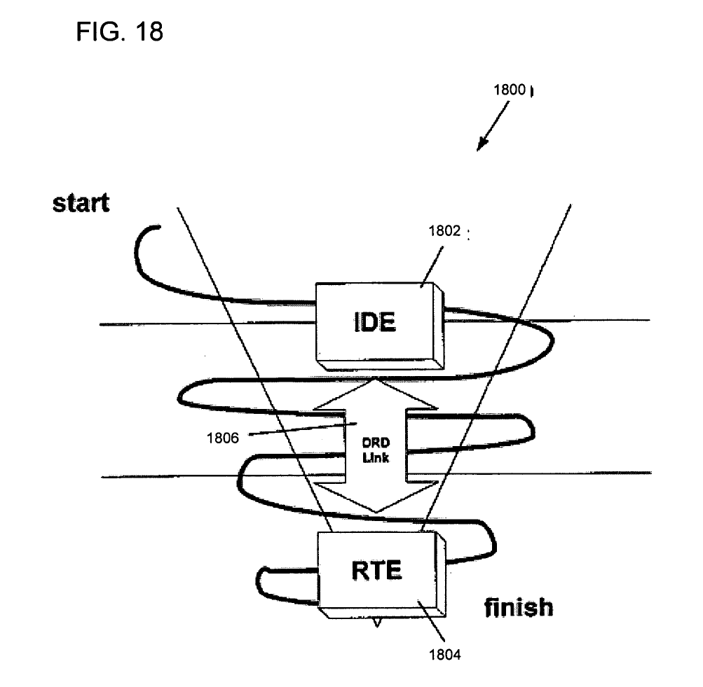

FIG. 18 is a process diagram illustrating how the lifecycle method is applied with a linked IDE and RTE, according to an exemplary embodiment of the present disclosure.

The development phase 1202, FIG. 12, has prototype cycles 1800 and uses a spiral process to move through the “V”. In developing parts of the model, an IDE 1802 is required. In testing, calibrating, and validating parts of the implementation model, a RTE 1804 is required. To effectively move along the spiral process, the IDE 1802 and RTE 1804 should be linked via a DRD link 1806. The IDE 1802 is mainly applied on the top and middle of the “V”, and the RTE 1804 is applied on the bottom of the “V”. The spiral process that moves through the “V” is enabled by the linked IDE 1802 and RTE 1804. The linkage is required during “down cycles” and “up cycles”. In the “down cycle” the information flow is mainly from the IDE 1802 to the RTE 1804 because the focus is on ending with an implementation as a RTE 1804.

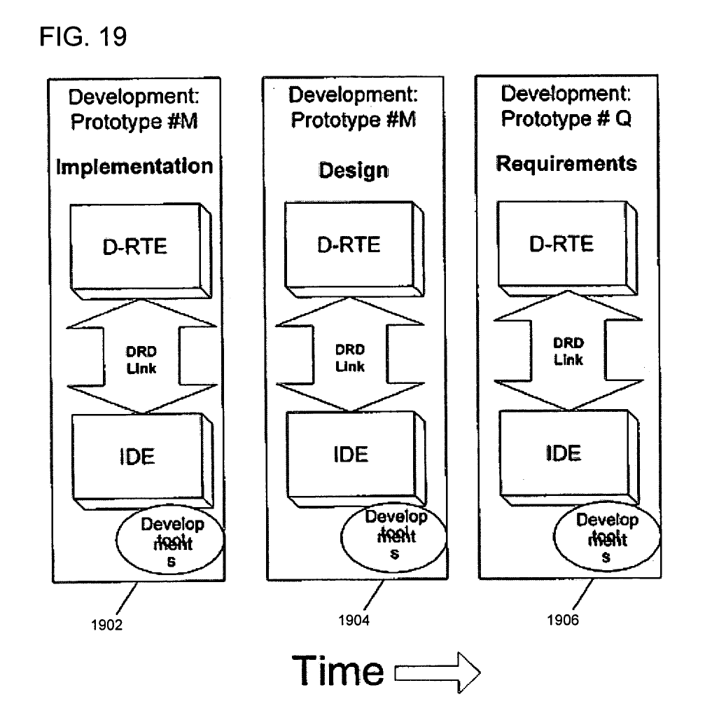

FIG. 19 is a process diagram illustrating how the lifecycle method progresses, according to an exemplary embodiment of the present disclosure.

The development phase 1202, FIG. 12, progresses through prototyping cycles 1902, 1904, 1906. Each cycle eventually moves through an “up cycle” in the “V” that includes the integration, testing, calibration, and validation of the model in terms of the attributes of implementation, then design, and finally requirements. Early “up cycles” involve only requirements. Later “up cycles” involve requirements and design. Most prototyping cycles in the development phase will include the development of the model in terms of the attributes of requirements, design, and implementation in the “down cycle” followed by the integration, testing, calibration, and validation of the implementation, design, and requirements in an “up cycle”.

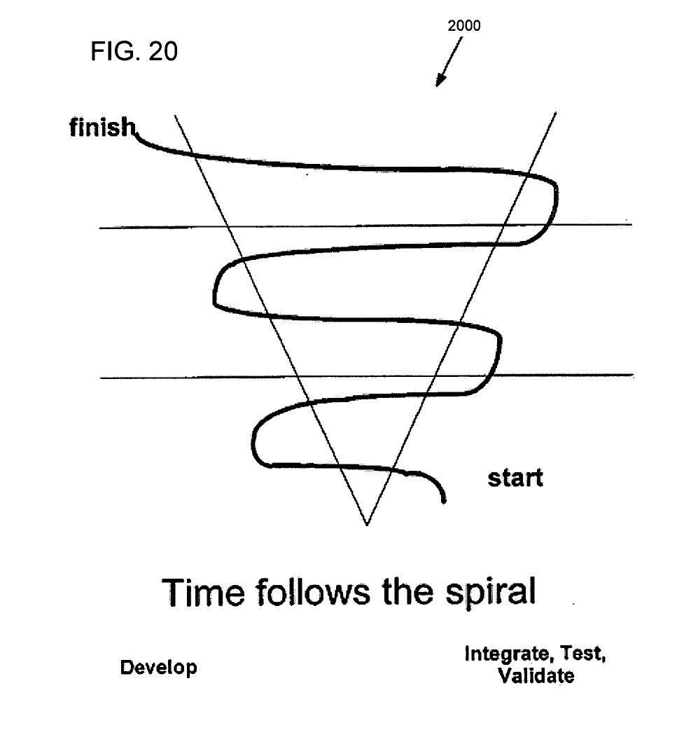

FIG. 20 is a process diagram illustrating how the lifecycle method applies a spiral sub process, according to an exemplary embodiment of the present disclosure.

The development phase 1202, FIG. 12, includes prototype cycles. The cycles use a spiral process 2000 to move through the “V” initially in a “down cycle” and then in an “up cycle” as illustrated. With the spiral process, parts of the implementation attributes of the prototype model are integrated and then tested, followed by parts of the design being developed and then tested, and then parts of the requirements attributes are then tested and validated.

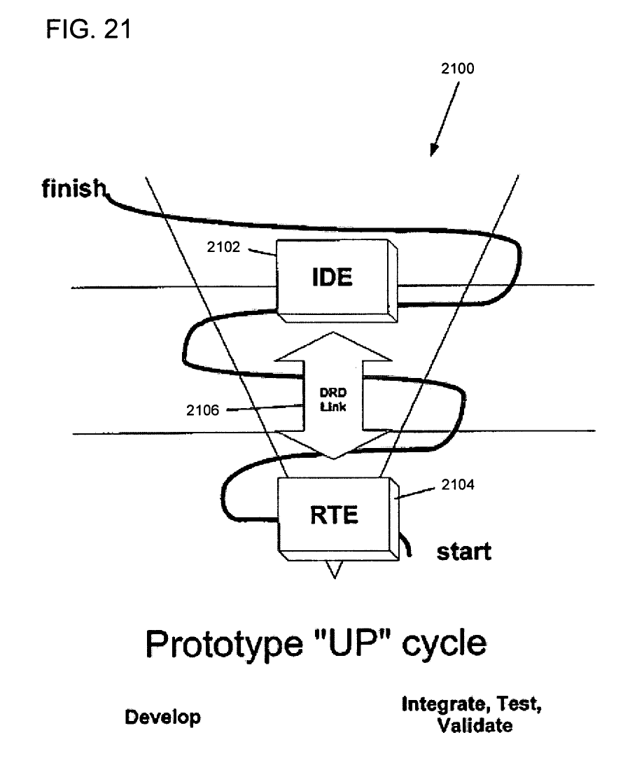

FIG. 21 is a process diagram illustrating how the lifecycle method is applied in the spiral sub process, according to an exemplary embodiment of the present disclosure.

The development phase 1202, FIG. 12, has prototype cycles and uses a spiral process 2100 to move through the “V”. In developing parts of the model, an IDE 2102 is required. In testing, calibrating, and validating parts of the implementation model, a RTE 2104 is required. To effectively move along the spiral process, the IDE 2102 and RTE 2104 should be linked via a DRD link 2106. The IDE 2102 is mainly applied on the top and middle of the “V”, and the RTE 2104 is applied on the bottom of the “V”. The spiral process 2100 that moves through the “V” is enabled by the linked the IDE 2102 and the RTE 2104. The linkage is required during “down cycles” and “up cycles”. In the “up cycle”, the information flow is mainly from the RTE 2104 to the IDE 2102 because the focus is on ending with a validated model with a set of requirements and a design in the IDE.

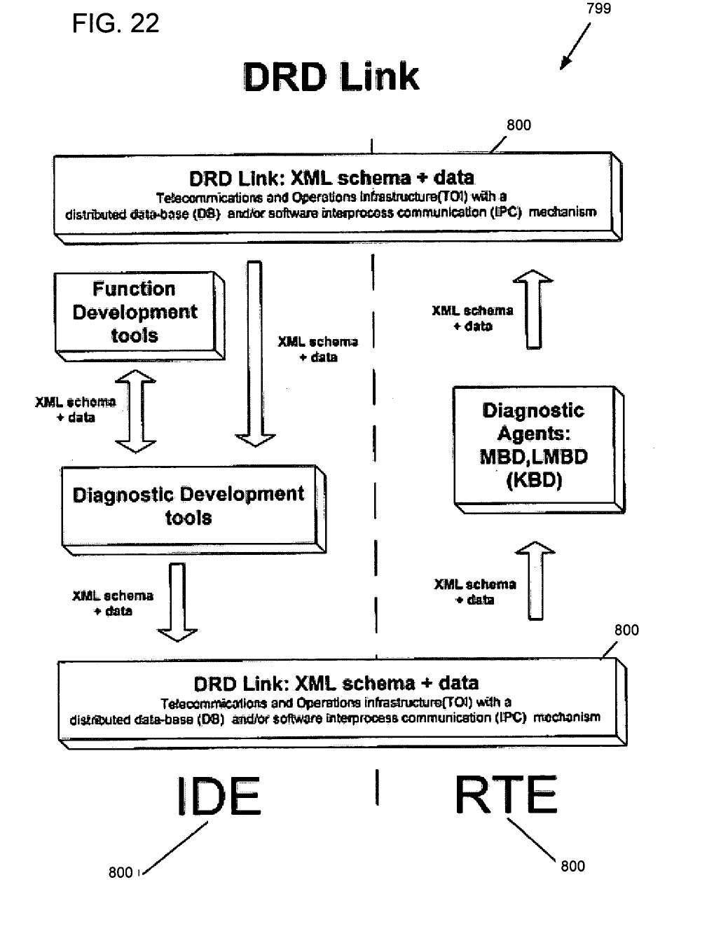

As shown in FIG. 22, a diagnostic agent, built with a specific DID-I that it reads as internal data, can detect a failure in a corresponding function's module in the RTE 900. The agent then accesses the DRD 899 to find the FID-I linkage to write information into the DRD 899 that can be read by any of the tools in the IDE 800 or by additional agents in the RTE 900. If the agent is in an ECU and the ECU has no direct access to the DRD 899, the agent sends a message to an agent in the TCU, which does have access to the DRD 899.

Once linked to the IDE 800, round-trip engineering of the diagnostics to functions is enabled using the linkages inside the IDE 800 guided by the information created in the DRD 899 by the RTE 900.

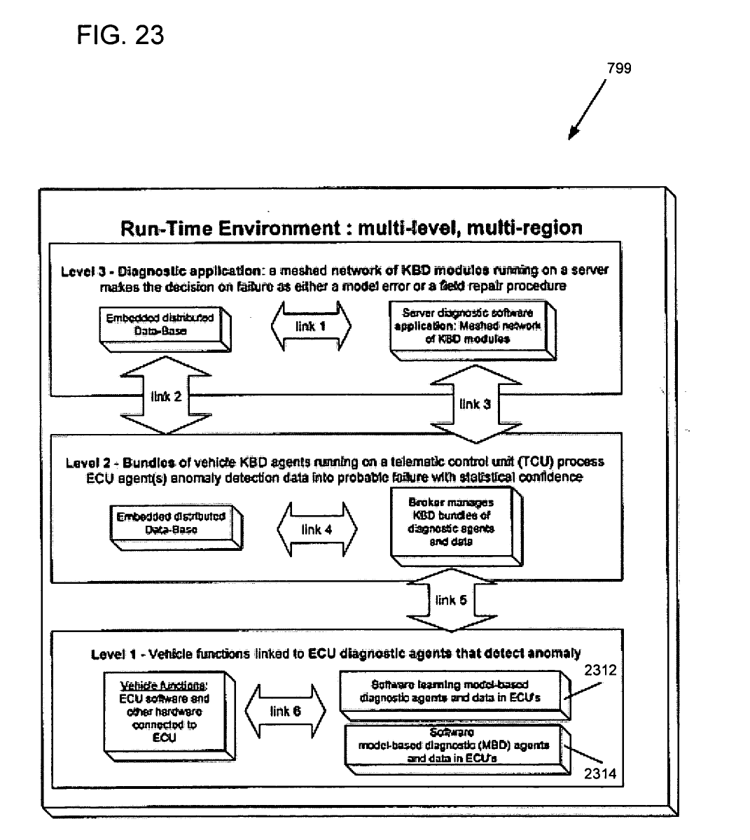

As shown in FIG. 23, the system 799 uses first and second agents 2312, 2314 to detect failures, faults, or anomalies. The second agent 2314 is a model-based diagnostic (MBD) agent that can use model and iterative procedures to determine a root cause for known failure modes. Examples of such agents are the MBD agents built using a tool, such as R.O.S.E. Rodon™. These MBD agents are not effective with new failures that were not anticipated in the model. To compensate for that gap in detection capability, the system 799 creates and applies the first agent 2312, or a learning model-based diagnostic (LMBD) agent, using embedded data mining algorithms, such as time-frequency analysis (TFA) or local models, that learn a model by observing an operating vehicle. These algorithms are trained and calibrated during specific normal operating times and then placed in a watch mode at run-time in the vehicle RTE 900.

In the system 799, the LMBD agents 2312 detect a superset of the failures detected by the MBD agents 2314. The LMBD failures can be classified as either (1) a previously anticipated failure that can be fixed in the field, or (2) a new failure that can be either a model error or another new type of hardware failure. The classification occurs by comparing the output of the MBD agents 2314 with the LMBD agents 2312. If the MBD agents 2314 have seen the failure mode before with a statistical confidence factor, then the failure is probably not a model error. If the MBD agents 2314 have a low confidence factor indicating a new failure mode not previously seen, then a model error needs to be investigated and the service technician is told not to swap a part in the field.

An investigation occurs as the RTE agents write information into the DRD link 899, FIG. 9, which enables the IDE 800, FIG. 8, to trace the failures back to the levels of the model represented at the levels of implementation, design and requirements. The system 799 identifies which functions are linked to the failure as discussed in the herein disclosed hierarchical or failure mode error determinations. A simulation can be run in the IDE 800, FIG. 8, to duplicate the failure mode. The simulation assists in the determination of the root cause. Thus, the LMBD agents 2012 can detect anomalies.

Referring now to FIG. 24, a schematic representation of methods and systems 2400 for anomaly detection is shown according to an exemplary embodiment of the present disclosure. System 2400 includes a regionalization tool 2402. The regionalization tool 2402 is responsive to data indicative of a tested system's operation. The regionalization tool 2402 is configured to use the data to identify a current operational region of the tested system. For example, the regionalization tool 2402 may accept as inputs the input of a hardware or software system. The regionalization tool 2402 determines the current operational region of the tested system based on the data.

The regionalization tool 2402 is linked to a performance assessment tool 2404 and can communicate the current operational region to that tool. The performance assessment tool 2404 compares actual operational behavior of the tested system in the current operational region to normal operational behavior of the tested system in the current operational region. The tested system can be partitioned into a plurality of operational regions, each having a relatively consistent system behavior. The tested system determines normal operational behavior from a model for the current operational region. The model can be a local linear model as described below.

Referring now to FIG. 25, a schematic representation of methods and systems 2500 for training an anomaly detector for a system are shown according to an exemplary embodiment of the present disclosure. In general, such methods and systems are used to provide a prediction of system behavior based on a discrete number of training observations, and may be embodied in a variety of hardware or software tools. System 2500 includes a collection module 2502. The collection module 2502 accepts data representative of the inputs and outputs of the tested system.

The system 2500 further includes a partition module 2504. The partition module 2504 is configured to partition the tested system into a plurality of operational regions. The partition module 2504 can train a regionalization tool in the anomaly detector in accordance with data. The data can be, for example, the data collected by the collection module 2502.

The system 2500 also includes a compute module 2506. The compute module 2506 computes a model 2508 of normal operational behavior of the tested system. The compute module 2506 may do such a computation for each of the plurality of regions created by the partition module 2504, and does so for at least one of the plurality of regions of the tested system. The compute module 2506 can be configured to operate on each of the plurality of regions serially, producing a model for each region on a “one region at a time” basis.

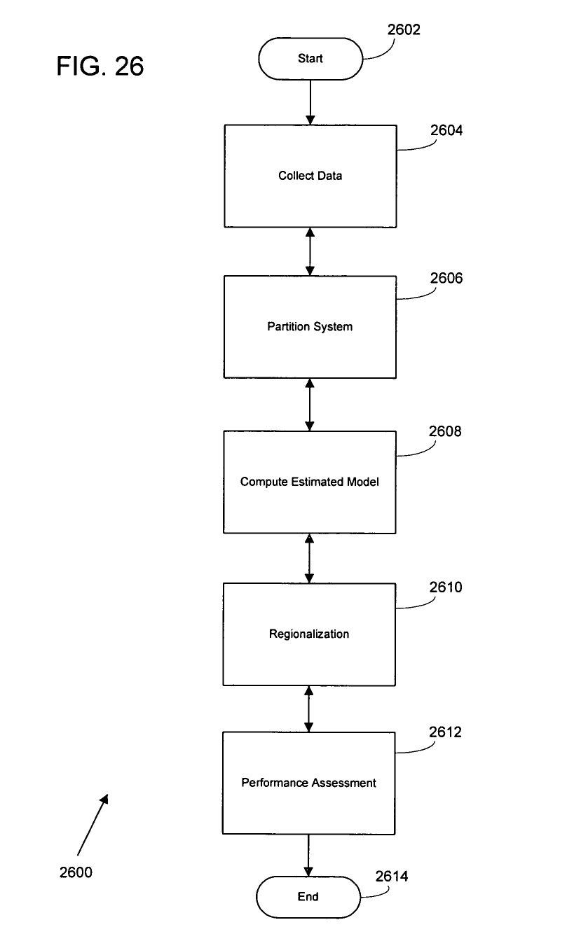

Referring now to FIG. 26, a schematic representation of methods and systems 2600 for anomaly detection are shown according to an exemplary embodiment of the present disclosure. The system 2600, as shown, is instantiated by a start module 2602. Following the start module 2602, operational flow is passed to a collection module 2604. The collection module 2604 accepts data from a tested system. The data should be representative of the inputs and outputs of the tested system. From observed outputs, initial conditions of the outputs can be estimated as well. For example, the collection module 2604 can accept inputs and known state values for a tested system. The tested system can be a system for which normal operation is expected, and to which the anomaly detection system 2600 can compare subsequent performance.

The system 2600 includes a partition module 2606. The partition module 2606 is configured to partition the tested system into a number of operational regions. The partition module 2606 can train a regionalization tool, such as regionalization module 2610 below, in accordance with data. The data used to partition the tested system can be, for example, the data collected by the collection module 2604.

The system 2600 includes a compute module 2608. The compute module 2608 is configured to compute a local model of normal operational behavior. The model of normal operational behavior can be based on the data collected by the data collection module. The compute module 2608 can do such a computation for each of the plurality of regions created by the partition module, and preferably does so for at least one of the plurality of regions of the tested system.

In the operation of a possible embodiment, the collection module 2604, partition module 2606, and compute module 2608 execute concurrently. For example, the collection module 2604 can collect a variety of data samples from a “baseline” normally operating system to be tested. The partition module 2606 may partition the tested system into a number of operational regions, or may partition those operational regions into a larger number of smaller-sized operational regions as additional data is collected by the collection module 2604.

The compute module 2608 can generate a model, such as a local linear model, from the collected data in the current operational region. The current operational region can be determined, for example, by a regionalization module 2610, described below. The compute module 2608 can update an estimated model using subsequent data it can receive from the collection module 2604. Further, the compute module 2608 can be configured to participate in generation or updating of an estimated model in other regions, such as neighbor regions to the current operational region.

The combination of the collection module 2604, the partition module 2606, and the execute module 2608 produce an estimated model of the tested system representative of normal operational behavior based on the data collected by the collection module 2604.

The system 2600 further includes a regionalization module 2610. The regionalization module 2610 is responsive to data indicative of the tested system's operation. The regionalization module 2610 is configured to identify a current operational region of the tested system. The regionalization module 2610 may accept as inputs the inputs and outputs of a hardware or software system to be tested. The regionalization module 2610 determines the current operational region of the tested system based on those inputs and outputs. The regionalization module 2610 selects from among the plurality of operational regions created by the partition module 2606.

The system 2600 includes a performance module 2612. In operation, the performance module 2612 compares actual operational behavior of the tested system in the current operational region to normal operational behavior of the tested system in the current operational region. The normal operational behavior of the tested system is based on a model derived from data collected from a normally operating system.

The system 2600 determines normal operational behavior from an estimated model for the current operational region. The estimated model, as generated by the compute module 2608, can be a local linear model. In an alternate embodiment, Time Frequency Analysis can be used.

Operational flow among the operations 2604-2612 is again ordered generally from training to testing. However, this does not require strict ordering, in that operations can execute in various orders, or in serial or parallel. Some ordering is apparent, in that some amount of initial data collection will take place before any partitioning module 2606 can execute and the compute module 2608 can derive a model. Furthermore, at least one operational region must exist for the regionalization module 2610 to determine the current operational region, and some “normal” and actual operational behavior must be available to determine performance in the performance module 2612.

The system 2600 terminates at an end module 2614.

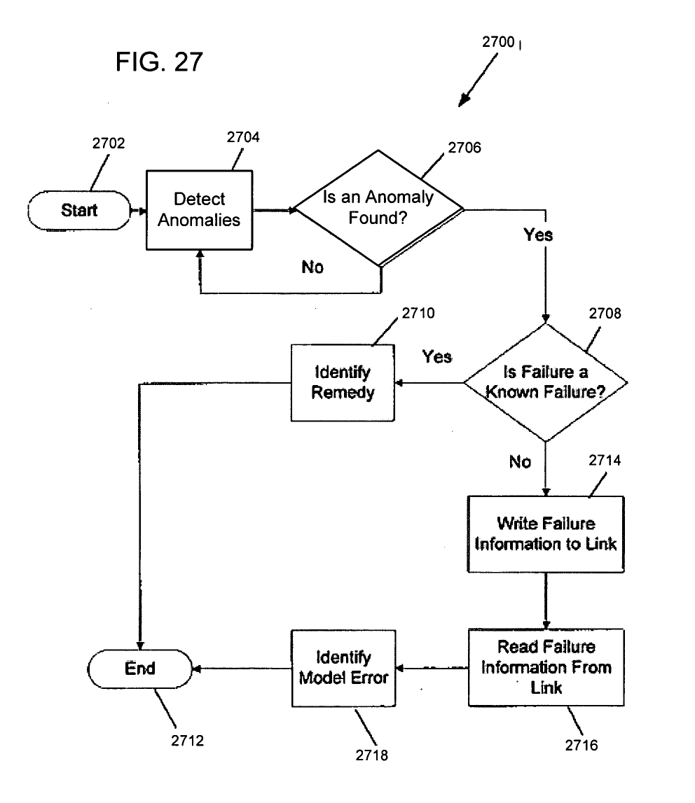

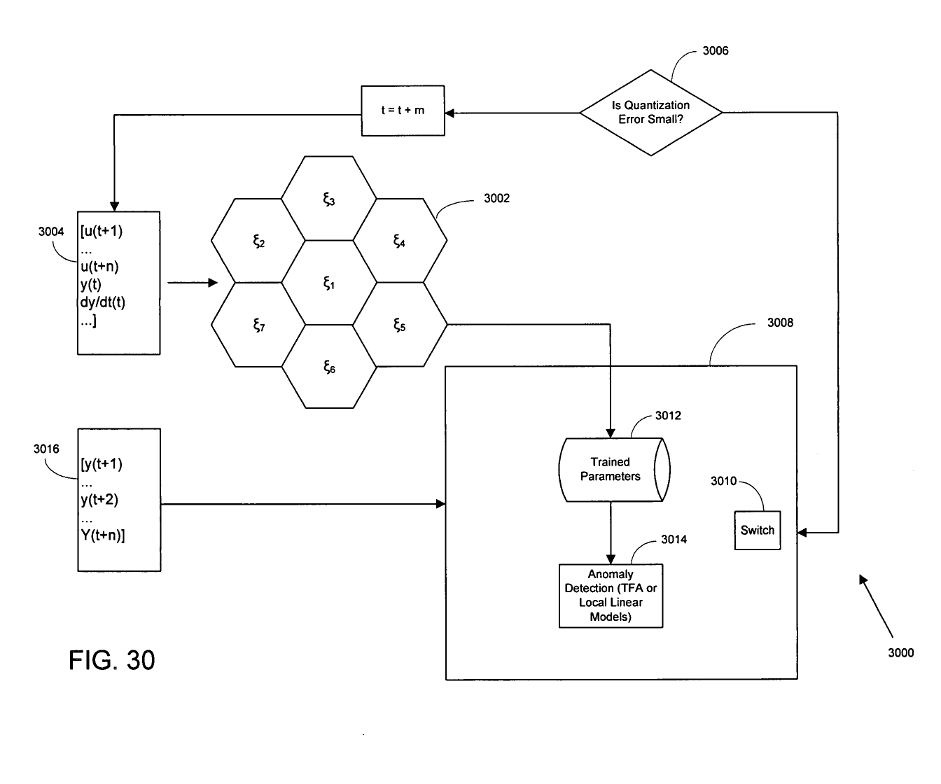

FIG. 27 is a flow chart representing logical operations of a learning model-based diagnostic system 2700. System 2700 can be used to implement aspects of the present disclosure, specifically when used in conjunction with the systems described below in FIGS. 30-32. Entrance to the operational flow of the learning model-based diagnostic system 2700 begins at a flow connection 2702. A detect operation 2704 detects an anomaly. It is noted that anomaly detection agents, such as those previously described herein, continuously monitor a vehicle's functions. Such agents can be located within the RTE, such as RTE 900 of FIG. 9, operating on a vehicle. A found module 2706 determines if an anomaly has been found. If the found module 2706 determines that a failure has not been found, operational flow branches “No” to the detect operation 2704. In this manner, the vehicle is continuously monitored for failures.

If the found module 2706 determines that an anomaly has been found, operational flow branches “Yes” to a known module 2708. The known module 2708 determines if the failure is a known failure. If the known module 2708 determines that the failure is a known failure, operational flow branches “Yes” to an identify operation 2710. The identify operation 2710 identifies the remedy for the known failure. Operational flow ends at termination point 2712.

If the known module 2708 determines that the failure is not a known failure, operational flow branches “No” to a write operation 2714. The write operation 2714 writes the failure information to a link, such as the DRD link 899 of FIG. 9. A read operation 2716 reads the failure information from the link. The failure is read into the IDE, such as IDE 800 of FIG. 8. A model operation 2718 identifies the model error, which may be an error is the requirements, design, or implementation level of the IDE. Operational flow ends at termination point 2712.

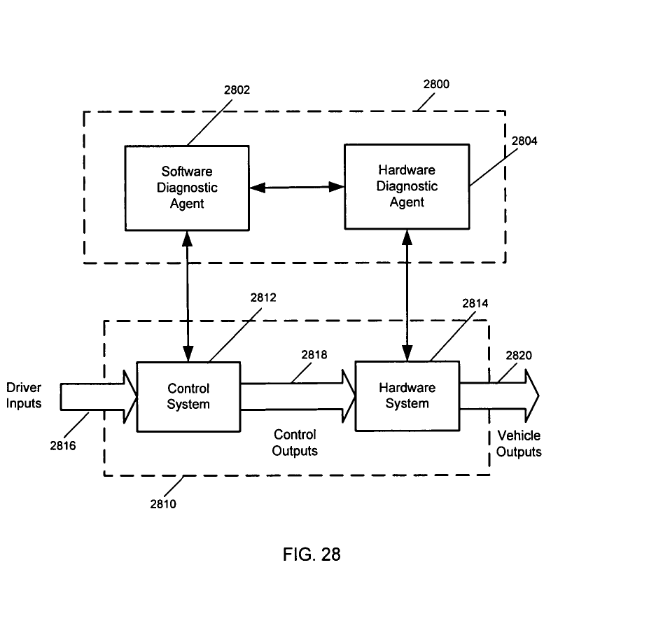

FIG. 28 is a block diagram illustrating a diagnostic layer 2800 that includes software diagnostic systems 2802 and hardware diagnostic systems 2804, which can contain for example, the LMBD agents 2012 of FIG. 20, or other anomaly detection agents or diagnostic agents. The diagnostic layer 2800 can run in an RTE, for example, the RTE 900 of FIG. 20. The diagnostic layer 2800 monitors a vehicle system 2810. The vehicle system 2810 includes a control system 2812 and a hardware system 2814. The control system 2812 receives driver inputs 2816 and provides control inputs 2818 to the hardware system 2814. The hardware system 2814 provides vehicle outputs 2820 to operate the vehicle.

The software diagnostic systems 2802 monitor the control system 2812. Likewise, the hardware diagnostic systems 2804 monitor the hardware system 2814. Preferably, the diagnostic systems 2802, 2804 detect anomalies in accordance with an anomaly detection scheme based on regionalization using self-organizing maps and local linear models or time frequency analysis. Of course, other suitable methods can be used.

Self-Organizing Maps (SOM) define a nonparametric regression solution to a class of vector quantization problems. Self-Organizing Maps are first described generally, followed by a specific application using growing structure and local modeling or Time Frequency Analysis in conjunction with the SOM for anomaly detection. This nonparametric regression method involves fitting a number of ordered discrete reference vectors to the probability distributions of input vectorial samples. SOM is similar to a Vector Quantization (VQ) technique, which is a classical data compression method that usually forms an approximation to the probability density function p(x) of stochastic vectors xεRⁿ, using a finite number of code vectors or code words ξᵢεRⁿ, i=1,2, . . . , M. For each codeword ξᵢ, a Voronoi set, or cell, can be defined as follows,
Vᵢ={xεRⁿ|∥x−ξᵢ∥≦∥x−ξⱼ∥, ∀ⱼ}
that contains all the vectors that are the nearest neighbors to the corresponding code vector ξᵢ. All the Voronoi sets construct a partition of the entire vector space Rⁿ. Therefore, once the codebook is determined according to some optimization criterion, then for any input vector x, it can be encoded into a scalar number c, called Best Matching Unit (BMU), whose associated code vector is closest to x, i.e.

$$c = arg {min}_{i} \{ ‖ x - {ξ}_{i} ‖ \}$$

A possible selection of the codewords ξᵢεRⁿ, i=1,2, . . . , M shall minimize the average expected quantization error function:
E=∫∥x−ξ_{c}∥² p(x)dx

It is noted that the index c is a function of input vector x and all the code vectors ξᵢ. It can be easily observed that c can change discontinuously. As a result, the gradient of expected quantization error E with respect to ξᵢεRⁿ, i=1,2, . . . , M is not continuously differentiable. Since the close form solutions for ξᵢεRⁿ, i=1,2, . . . , M that minimize are generally not available, one has to iteratively approximate the optimal solutions. It has been shown, in a particular case,

when ƒ(d(x,ξ_{c}))=∥x−ξ_{c}∥², the steepest descent can be obtained in the direction of −∇_{ξ}_{ᵢ}E|ₖ=2·δ_{cj}·(x(k)−ξⱼ(k)) at iteration step t, where δ_{cj} is the Kronecker delta function. If one defines the step size by the learning rate factor α(t) that includes the constant −2 from the gradient ∇_{ξ}_{ⱼ}E|ₖ=−2·δ_{cj}·(x(k)−ξⱼ(k)), then one arrives at an updating formula:
ξᵢ(k+1)=ξᵢ(t)+α(k)·δ_{ci}·(x(k)−ξᵢ(k))

The set of vectors ξᵢεRⁿ, i=1, 2, . . . , M obtained, which minimize the average expected quantization error E, can map the space of input vectors into a set of finite codebook reference vectors. However, the indexing of those reference vectors can be arranged in an arbitrary way, i.e. the mapping is still unordered. The reason is, for any input vector x, it can only affect the code vector that is nearest to it because of the delta function δ_{c} used in the updating formula.

The SOM can be interpreted as a nonlinear projection of a high-dimension sample vector space onto a virtually one or two dimension array that is represented by a set of self-organized nodes. Unlike the VQ technique, SOM is able to map high dimensional data onto a much lower dimensional grid, while preserving the most important topological and metric relationships of the original data elements. This kind of regularity of the neighboring reference vectors is coming from their local interactions, i.e. the reference vectors of adjacent nodes in the low dimensional grid up to a certain geometric distance will activate each other to learn something from the same input vector xεRⁿ, This results in a local smoothing effect on the reference vectors of the nodes within the same neighborhood and leads to global ordering. Due to this order property, the map tends to reveal the natural clusters inherent to input vector space and their relationships. Each node in the SOM is associated with a reference vector that has the same dimension as the input vector. The distance measure used in this disclosure is the well-known Euclidean distance.

In simple terms, the reference vector associated with the BMU yields the minimum Euclidean distance with respect to the input vector x. To ensure the global ordering of the SOM during learning process, one has to expand the influence region of the input vector, instead of only updating the reference vector of the BMU. One alternative is to replace the delta function δ_{cj} with a new neighborhood function h(●) that depends on time k and the distance between two nodes c and i on the low dimensional grid. This gives the following formula for the reference vectors:
ξᵢ(k+1)=ξᵢ(k)+α(k)h(k,dis(r_{c},rᵢ))(x(k)−ξᵢ(k))
where k=0,1, . . . is the discrete time index, α(k) is the learning rate factor and r_{c},rᵢ are locations of nodes c and i in the low dimensional grid respectively. This is similar to the vector quantization updating function above, but is different at least in that it allows soft competitive learning, i.e. system training outside the current operational region. For convergence of the network, it is necessary that as h(k, dis(r_{c}, rᵢ))→0 when k→∞. In addition, the degree of the “elasticity” of the network is related to the average width of the neighborhood function h(k,dis(r_{c},rᵢ)), where h(k,dis(r_{c},rᵢ))→0 with increasing dis(r_{c},rᵢ). A common choice for the neighborhood function is

$$h ( k , dis ( {r}_{c} , {r}_{i} ) ) = exp ( - \frac{{dis ( {r}_{c} , {r}_{i} )}^{2}}{2 {σ}^{2} ( k )} )$$

where and σ(k) defines the width of the neighborhood function. They are both monotonically decreasing functions of time.

For small sized SOMs, the choice of those parameters is not important, for example, a few hundred nodes. However, for very large SOM, those parameters have to be chosen carefully to ensure convergence and global ordering of the reference vectors. The computation steps of the algorithm can be summarized as follows:

1. Choose the size and topology of the maps, initialize the set of reference vectors ξᵢεRⁿ,i=1, 2, . . . , M by setting them randomly, or for instance, choose the first k copies of the first training vectors x.

2. Find the BMU for the input vector x(t), and adjust the reference vectors of BMU and its neighborhood units.

3. Repeat step 2, until the changes of reference vectors are not significant.

A batch computation algorithm of SOMs (Batch Map) is also available if all the training samples are assumed to be available when learning begins. It resembles the K-means algorithms for VQ, particularly at the last phase of the learning process when the neighborhood shrinks to a set only containing the BMU. This Batch Map algorithm contains no learning rate factor, thus has no convergence problems and yields more stable values for the reference vectors ξᵢεRⁿ, i=1, 2, . . . , M.

Different learning process parameters, initialization of the reference vectors ξᵢ(0)εRⁿ,i=1,2, . . . , M, and sequence of training vectors x(t) can result in different maps. Depending on the criterion of optimality, different SOMs can be considered optimal, for example, the average quantization error. The average quantization error, which is the mean of ∥x−ξ_{c}∥, is a meaningful performance index that can measure how well the map is fitted to the set of training samples. Further information regarding SOMs can be found in the following references, and the references therein, all of which are incorporated herein by reference:

Kohonen, T., Oja, E., Simula, O., Visa, A., Kangas, J. (1996),“Engineering applications of the self-organizing map”, Proceedings of the IEEE, v 84, n 10, p 1358-1384

Kohonen, T. (1995), Self-Organizing Maps. Springer, Berlin, Heidelberg.

A variety of partitioning methods can be used to partition the system dynamic behaviors into different operational regions. To accomplish this regionalization, one first might attempt to find an appropriate base on which the regionalization can be conducted. In one embodiment, variety of the physical system, such as mechanical, electrical, electromechanical, thermal, and hydraulic systems, might be modeled by n^{th} order ordinary differential equations, such as those of the following form,
y⁽ⁿ⁾=F(t,y,y^{t},yⁿ, . . . y⁽ⁿ⁻¹⁾, u,u^{t}, . . . ,u^{(m)})
where y^{t},yⁿ, . . . y⁽ⁿ⁾are the derivatives of the system outputs up to n^{th} order and u,u′, . . . , u^{(m)} are the inputs and their derivatives up to m^{th} order. If the inputs, denoted as u=μ(t)=[u₁(t),u₂(t), . . . , uₚ(t)]^{T} have been specified as piecewise continuously differentiable functions up to m^{th} order, we can eliminate u and its derivatives to yield
y⁽ⁿ⁾=γ(t,y,y,y^{t},yⁿ, . . . y⁽ⁿ⁻¹⁾)

It can be proven using the global existence and uniqueness theorem in Khalil, H. (2002), Nonlinear Systems, 3rd edition. Prentice-Hall, N.J., that if γ(t,y,y^{t},yⁿ, . . . y⁽ⁿ⁻¹⁾ is piece-wise continuous in t and satisfies the Lipschitz condition
∥γ(t,y₁)−γ(t,y₂)∥≦L∥y₁−y₂∥, ∀y₁,y₂εRⁿ, ∀tε[t₀,t₀+τ]
where yᵢ=[yᵢ,yᵢ^{t},yᵢⁿ, . . . , yᵢ⁽ⁿ⁻¹⁾]^{T} and L is a finite positive number, then the n^{th} order ordinary differential equation with initial conditions

$${[ y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , \frac{{ⅆ}^{n - 1} y}{ⅆ {t}^{n}} {\vert}_{t = {t}_{0}} ]}^{T} = {y}_{0}$$

has a unique solution over the time interval [t₀,t₀+τ].

Suppose that F(●) is piece-wise continuous in t and it arguments, then it follows from the assumption that the inputs and their derivatives u,u′, . . . , u^{(m)} are piece-wise continuous in t, γ(t,y,y^{t},yⁿ, . . . y⁽ⁿ⁻¹⁾) is always piece-wise continuous in t. Therefore, once the Lipschitz condition is satisfied, the system output y over the time interval [t₀,t₀+τ] can be uniquely determined by the inputs u during time interval [t₀,t₀+τ] and the initial conditions

$${y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , \frac{{ⅆ}^{n - 1}}{ⅆ {t}^{n}} {\vert}_{t = {t}_{0}} ]}^{T}$$

of output y at time t₀. Therefore, the concatenated vector of the output and its derivatives at time t₀, and the input sequences u(t) during a given time interval [t₀,t₀+τ],

$${[ y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , \frac{{ⅆ}^{n - 1} y}{ⅆ {t}^{n}} {\vert}_{t = {t}_{0}} , {u}^{T} ( {t}_{0} ) , … , {u}^{T} ( {t}_{0} + τ ) ]}^{T}$$

contains all the information necessary to determine the system outputs during the time interval [t₀,t₀+τ] This observation indicates that the regionalization can be based on the concatenated vector in the form of (4.4).

We note that the condition specified above is only a sufficient condition for the outputs during [₀,t₀+τ] to be uniquely determined by the initial conditions of the output at time t₀ and the inputs during [t₀, t₀+τ] For general nonlinear system, obtaining a necessary and sufficient condition is well beyond the scope of this paper. In general, the condition is closely related to system observability.

A tremendous number of system behavior patterns impose a great challenge on anomaly detection and localization, or regionalization. Traditional model-based faults diagnosis techniques are unsuitable for many cases, since detailed knowledge about the underlying physical system is not available. The system can only be viewed as a black box. Therefore, there is a need to find a way that can approximately build a model that relates the system inputs and outputs. Preferably, the system is partitioned into different regions, based on the inputs sequences and initial conditions of outputs.

If we concatenate the initial conditions of the outputs including

$$y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , \frac{{ⅆ}^{n} y}{ⅆ {t}^{n}} {\vert}_{t = {t}_{0}}$$

and the input sequences u(t) during a certain time interval [t₀,t₁] together to form a big vector as follows:

$${[ y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , \frac{{ⅆ}^{n} y}{ⅆ {t}^{n}} {\vert}_{t = {t}_{0}} , u ( {t}_{0} ) , … , u ( {t}_{0} + τ ) ]}^{T}$$

where

$$y ( {t}_{0} ) = [ {y}_{1} ( {t}_{0} ) , … , {y}_{q} ( {t}_{0} ) ] , \frac{ⅆ y}{ⅆ t} {\vert}_{t = {t}_{0}} = [ \frac{ⅆ {y}_{1}}{ⅆ t} {\vert}_{t = {t}_{0}} , … , \frac{ⅆ {y}_{q}}{ⅆ t} {\vert}_{t = {t}_{0}} ]$$

and soon. This vector contains all the information necessary to determine the system outputs. However, in real applications, this vector usually has a very high dimension. Therefore, SOMs is used to regionalize the space spanned by those vectors, because of its excellent capability of visualization of high dimensional data. The Voronoi sets use all the reference vectors of the trained SOM, to form a partition of the entire space spanned by the vectors. The Voronoi set is referred to as a system “operational region”.

Methodologies for anomaly detection, such as the time-frequency analysis and local modeling described herein, can be enhanced by the regionalization accomplished using a Self-Organizing Map. In the general SOM case, the problem of determining the precise number of regions is largely unsolved, since no prior knowledge may be available about the system except its input and output signals. In the above description of Self-Ordering Map initialization, the number of Voronoi cells included in the map must be judiciously chosen before system operation using guesses about system behavior. This is particularly the case when SOMs are used in conjunction with a local model, which would tend to have increased error in sparsely populated operational regions. In such a SOM, frequently visited regions will have finer partitions and generally smaller fitting areas. However, regions having high nonlinearity that are not frequently visited are poorly approximated. In such regions a linear model may be non-optimal due to the inherent error of modeling a nonlinear system with a linear model.

This disclosure contemplates a solution that allows for more uniform organization of observed values by starting with a very low number of nodes and adding additional nodes to areas in which the system is most highly nonlinear or where modeling errors are the highest. This node addition results in creating smaller Voronoi sets, or operational regions in this disclosure, in regions which are likely to be highly nonlinear. This Voronoi cell-splitting technique allows models to more accurately represent these regions by improving their linearity. This node addition, referred to herein under the generalized term “growing structure competitive learning”, is accomplished during the training process, growing the size of the SOM as additional inputs are added to the various operational regions.

In the generalized SOM, the regionalization of data points is optimal only in the sense of minimizing the expected square of quantization error, represented as ∫∥x−ξ_{c}∥ƒₛ(x)ds, where ξₘ, i=1, . . . , M is a set of weight vectors and c is the index of the best matching unit, as described above. Conversely, the systems according to the preferred embodiment can be configured to add nodes while attempting to minimize the square of the expected modeling error, E [∥y−ŷ(s)²∥].

This splitting strategy promotes evenly distributed accumulated modeling error, a tradeoff between density and modeling errors corresponding to each local model. Additional embodiments may incorporate a penalty term expressing a relative nonlinearity measure dependent on fitting errors.

In an alternate embodiment, the system may insert additional nodes near the region where the dynamic nonlinearity is high, or equivalently, where the local expected mean square error is large. Since the mean square modeling error is not affected by the visiting frequency to the operational region, this may be favorable for approximating the distribution of the tested system's dynamic nonlinearities.

In order to incorporate such a growing mechanism into the growing structure model, the local model adaptations must be fast enough to follow the dynamics of the modified configurations due to the newly inserted nodes in the network. In a preferred embodiment a recursive least square algorithm with exponential forgetting is used for local linear model parameter estimation. The updating rate can be adjusted through the forgetting factor λ in the local linear model estimations discussed below. For example, varying the forgetting factor λ from 0.95 to 0.99 corresponds approximately to remembering the 20 to 100 most recent inputs in generating the local model estimation.

By using a growing structure competitive learning system, the anomaly detection scheme of this disclosure can be instantiated with a small number of operational regions when initialized, adding more operational regions where the tested system is nonlinear, i.e. the squared expected modeling error is high.

Two methods for anomaly detection contemplated by the present disclosure incorporate either time-frequency analysis or local modeling to predict behavior of a tested system. Each compares the tested system's “expected” output to its actual output. If the actual output is, in general, far enough “off” from the expected output, then an anomaly is considered to be present. Each of these methods is now described briefly.

Time frequency analysis (TFA) has long been recognized as a powerful non-stationary signal processing method and has been widely applied into different areas, such as radar technology, marine biology, and biomedical engineering. Unlike the well-known Fast Fourier Transform (FFT) that can only decompose the signal into frequency components, but does not depict the time location related information, TFA is capable of decomposing the signal into both time and frequency simultaneously. This makes TFA an appropriate method to analyze signals, in which the frequency contents of the signal change over time. It may be difficult to detect permutations of signal components in a control system using FFT, but is much easier using TFA. Capability of dealing with non-stationary signals makes TFA quite suitable to process signals from complex control systems, such as automobiles or aircrafts.

Consider a two-dimensional distribution p_{X,Y} (x, y), whose characteristic function is given by:
φ(η,ξ)=E[e^{jXη+jYξ}]=∫∫e^{jxη+jyξ}p_{X,Y}(x,y)dxdy

It can be approximated by a Taylor series, Cohen, L. (1994), Time-Frequency Analysis, Prentice Hall, incorporated herein by reference, and the characteristic function can be expressed as

$$ϕ ( η , ξ ) = {\sum }_{p + q = 0}^{N} \frac{{j}^{p + q}}{p ! q !} E ( {X}^{p} {Y}^{q} ) {η}^{p} {ξ}^{q} + o [ {( {η}^{2} + {ξ}^{2} )}^{\frac{n}{2}} ]$$

Since the time-frequency distribution can be uniquely determined by its characteristic function, the sequence of moments E(X^{p}Y^{q}) can be used to describe the distribution p_{X,Y}(x, y).

However, the moment sequence is infinitely long and hence cannot be directly used as a feature set. Furthermore, moments of different orders are highly correlated with each other. Nevertheless, only moments of the lower order describe the general properties of the time frequency distribution, and hence we can truncate the moment sequence in order to approximately represent a time frequency distribution. In order to remove connections between moments and to reduce dimensionality of the moment vector, further processing is necessary. This can be achieved through Principal Component Analysis (PCA), Richard, O. Duta, P., David G. (2000), Pattern Classification, Wiley, 2^{nd} edition, incorporated herein by reference, which is an appropriate dimensional reduction method since the time frequency moments are asymptotically Gaussian, Salutes, E. J., O'Neill, J. C., Williams, W. J. and Hero, A. O., “Shift and Scale Invariant Detection,” in Proc. IEEE Int. Conf. Acoustic, Speech, and Signal Processing, vol. 5, 1996, pp. 3637-3640, incorporated herein by reference.

Due to asymptotic Gaussianity and independence of the principle components, the Mahalanobis distances between feature vectors are asymptotically following the χ² distribution with r degrees of freedom, where r is the number of extracted principal components. Therefore, the deviation of the signals from the training set, which represents the normal distribution, can be measured by the probability that the Mahalanobis distance is within a certain range. This probability is referred to as a confidence value (CV) indicating the degree of the deviation from normal state. For more detailed information, see Djurdjanovic, D., Widmalm, S. E., Willians, W. J., Koh, C. K. H. and Yang, K. P. (2000), “Computerized Classification of Temporomandibular Joint Sounds”, IEEE transaction on biomedical engineering, vol. 47, No. 8, herein incorporated by reference.

Local models provide an efficient method for deriving “normal” operational behavior of a system based on a finite training sample set. Such models are used in the present disclosure in the context of growing, self-ordering maps. Local modules are used herein as follows. Assume the system dynamics can be described by a Nonlinear Auto-Regressive model with eXogenous input (NARX)
y(k+1)=F(y(k), . . . , y(k−nₐ +1), u(k−n_{d}), . . . , u(k−n_{d}−n_{b}+1))
where u(k)εR^{p} are the system inputs, y(k)εR^{q} are the system out-puts, n_{d} is the time lag from the moment that the excitation is applied until the effects are manifested through the outputs, and nₐ and n_{b} are the order of the model.

If F(●) is differentiable at a point so in the reconstruction space, which is spanned by vectors of the form
s^{T}(k)=[y^{T}(k), . . . , y^{T}(k−nₐ+1), u^{T}(k−n_{d}), . . . , u^{T}(k−n_{d}−n_{b}+1)], the Taylor series expansion of F(●) is provided as

$$F ( s ) = F ( {s}_{0} ) + \frac{\partial F}{\partial s} ( {s}_{0} ) ( s - {s}_{0} ) + \frac{1}{2 !} {( s - {s}_{0} )}^{T} \frac{{\partial }^{2} F}{\partial {s}^{2}} ( {s}_{0} ) ( s - {s}_{0} ) + …$$

The higher order terms such that the limit of the absolute value of their squares is zero as s approaches s₀. So, within a small region around so, the approximation errors can be arbitrarily small. For example, if we choose the first two terms of the Taylor series expansion, F(s) can be approximated using a set of local models as follows:
Fᵢ(s)=bᵢ+aᵢ^{T}s, i=1, . . . , M
Notice that the local model is linear in terms of its parameters bᵢ and aᵢ that need to be estimated. It is noted that in instances where local models are nonlinear in terms of their parameters, a more sophisticated optimization procedure may be required to find the model parameters. Some physical insights into the system to be tested may be valuable in simplifying the local model structures chosen.

In still other alternative embodiments, other functional forms can be used to locally approximate the nonlinear function within a small region around a point, such as r^{th} order polynomials. Such alternative representations may have additional parameters that must be estimated.

The overall system dynamics can then be approximated through the combination of the local models through a gating function as follows:

$$\hat{y} ( k + 1 ) = {\sum }_{i = 1}^{M} {g}_{i} ( s ( k ) ) {F}_{i} ( s ( k ) ) ,$$

where gᵢ(s(k)) could be the Kronecker delta function:

$${g}_{i} ( s ( k ) ) = \{ \begin{matrix}1 , s ( k ) ∈ {i}^{th} region \\ 0 , s ( k ) ∉ {i}^{th} region\end{matrix}$$

In this case, only one local model can “win” the competition to be the current operational region. Other types of gating function can also be used here to weight local models together to approximate the global system dynamics, such as radial basis functions.

Without loss of generality, we assume the dimension of the input and output is one for notation convenience. A widely accepted method for local model identification is to find the model parameters that minimize the sum of the weighted squared residuals in each operation region.

$${J}_{i} ( {θ}_{i} ) = \frac{1}{k} {\sum }_{j = 1}^{k} {w}_{i} ( s ( j ) ) {λ}^{k - j} {‖ y ( j ) - {\hat{y}}_{i} ( j ) ‖}^{2}$$

In this embodiment, model parameters θᵢ represent the model parameters to be estimated for the i^{th} region, and λ is the forgetting factor that adjusts the speed of the adaptation of parameter estimation. This forgetting factor is necessary to allow the system to adapt to changes of regionalization that will occur as the model is trained. wᵢ(s(k)) is the weight for the k^{th} observation when updating the model parameters for the i^{th} region.

Since using the SOM training process above results in the operational space being divided into small regions, during the training process, whenever a training pair s(k)→y(k) becomes available, after finding the BMU based on vector s(k) it is advantageous to update the local models of the BMU and the models of other adjacent regions. In updating the adjacent, or “neighborhood” regions, not all weights can be the same, in order to prevent the system's convergence to a single local model. Therefore, as the region gets farther away from the BMU, the smaller the weight applied to that region. Specifically, this cooperative learning strategy among neighboring regions can improve the convergence speed of the algorithm and the effects are more significant at the beginning of the learning. In addition, this neighborhood updating process allows for smoothing effects at the boundaries of operational regions, and additionally allows for global ordering of the local models A weighting factor wᵢ(s(j)) is introduced that determines the importance of observation s(j) on the estimation of the parameters of local model in region i. In one implementation, the weights can be inversely proportional to the distance between the location of the region and BMU on the network. For example, the neighborhood function which measures memberships of a given observation can be used

$${w}_{i} ( s ( k ) ) = exp ( \frac{- {dis ( ⅈ , c ( k ) )}^{2}}{2 {σ}^{2} ( k )} ) = h ( k , dis ( ⅈ , c ) )$$

Minimizing Jᵢ(θᵢ) is performed recursively, as follows, using Pᵢ(0)=P₀ (a diagonal matrix whose elements is large) and \hat{θ}ᵢ(0)=\hat{θ}ᵢ₀ as initial values for the recursion to startup:

$${L}_{i} = \frac{{P}_{i} ( k - 1 ) s ( k )}{\frac{λ}{{w}_{i} ( s ( k ) )} + {s}^{T} ( k ) {P}_{i} ( k - 1 ) s ( k )}$$

$${\hat{θ}}_{i} ( k ) = {\hat{θ}}_{i} ( k - 1 ) + {L}_{i} ( k ) [ y ( k ) - {\hat{θ}}_{i}^{T} ( k - 1 ) s ( k ) ]$$

$${P}_{i} ( k ) = \frac{1}{λ} [ {P}_{i} ( k - 1 ) - {L}_{i} ( k ) {s}^{T} ( k ) {P}_{i} ( k - 1 ) ]$$

During the training process, the local model should be updated as additional data points become available and as additional operational regions are created.

Besides the local model parameters, the structural parameters including the locations of operational regions have to be identified. Most of the local modeling techniques utilizing self-organizing networks in the literature separate the modeling procedure into two independent stages: regionalization and local model fitting. The conventional self-organizing network normally aimed at minimizing the expected square of the quantization error. Non-uniformity in the distribution of visiting frequencies in the training data set may result in more weight vectors being associated with the region which the system frequently visits. This may result in regions which are highly nonlinear, but not frequently visited, being poorly approximated by fewer local models. Therefore, it is clear that in order to achieve a better modeling performance for a specific application, one needs to balance between the visiting frequencies and modeling errors across different regions. This will be realized by adding a penalty term to the learning rate of the weight vector updating
ξᵢ(k+1)=ξᵢ(k)+α(k)ζᵢ(k)h(k, dis(r_{c},rᵢ))(x(k)−ξᵢ(k))
where ζᵢ(k) is the penalty term penalizing the amount of movement to achieve a balance between the effects of visiting frequency and modeling errors in different regions.

Introduction of such a penalty term is to achieve finer partitions where the local model fitting errors are high. In this paper, the normalized modeling errors are used to penalize the movements of the weight vectors in each region at training step k for sequential training

$${ζ}_{i} ( k ) = \frac{{e}_{i}^{ewma} ( k )}{{max}_{j} \{ {e}_{j}^{ewma} ( k ) \}}$$

$$\begin{matrix}{e}_{i}^{ewma} ( k ) = \\ [ {λ}_{max} + ( {λ}_{min} - {λ}_{max} ) {w}_{i} ( s ( k ) ) ] {e}_{i}^{ewma} ( k - 1 ) + \\ [ 1 - {λ}_{max} - ( {λ}_{min} - {λ}_{max} ) {w}_{i} ( s ( k ) ) ] ‖ {e}_{i} ( k ) ‖\end{matrix}$$

where eᵢ(k)=y(k)−ŷᵢ(k) represents the output error for the i^{th} local model at training step k. The “ewma” designation reflects the fact that the error is based on an exponential weighted moving average of training points, and becomes less significant when the corresponding node is further away from the best matching unit on the network. This provides a direct feedback from the local model fitting errors to the system regionalization process. It has the effect of moving the weight vectors toward the region where system nonlinearity is high.

Once a diagnostic agent is trained using a normally operating or known-erroneous system, the same diagnostic agent can detect suddenly occurring as well as gradually occurring anomalies by comparing actual system output to the model or distribution based on tested system input. The current operational region is determined, and a determination is made as to whether the difference between the actual and known output is outside a residual error threshold. The residual error threshold is based generally on the tested system's predictability, and can be computed independently for each region.

The residual error threshold can be set for each operational region to prevent false anomaly detection in sparsely trained regions. A lower predictability (i.e. by higher nonlinearity within a region) will indicate a less predictable region, and will have a looser threshold. Therefore, a large variation from the normal operational behavior would be required for an anomaly to be detected. Conversely, a higher predictability will result in a lower threshold. In such cases, the residual error would be expected to be tighter in that operational region, so a smaller deviation from normal operational behavior would be detected as an anomaly.

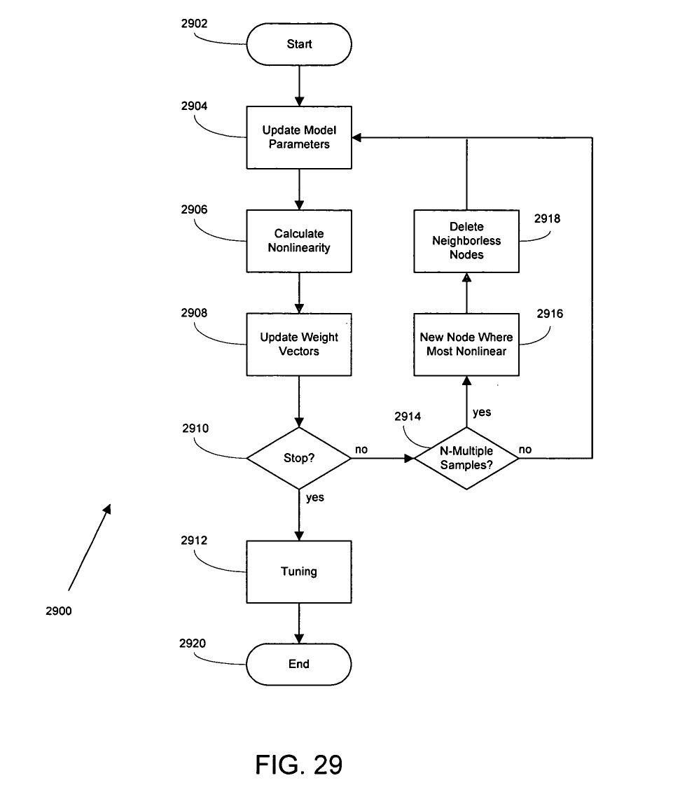

FIG. 29 is a flow chart representing a sequential training system 2900. System 2900 can be used for a growing structure competitive learning model, such as are disclosed herein. Operational flow to the system 2900 is instantiated at a begin operation 2902. An update operation 2904 can update model parameters, such as the parameters θᵢ(k) of the local models. Operational flow proceeds to a nonlinearity module 2906. The nonlinearity module can calculate a nonlinearity measure, such as nonlinearity ζᵢ(k) of the i^{th} operational region. Operational flow proceeds to an update module 2908. The update module 2908 updates the weight vectors in the self-ordering network, such as via the previously discussed equation
ξᵢ(k+1)=ξᵢ(k)+α(k)ζᵢ(k)h(k,dis(r_{c},rᵢ))(x(k)−ξᵢ(k)).

A stop operation 2910 determines if the stopping criteria are met. Stopping criteria may be set, for example, based on the desired accuracy, actual test runtime, or other factors related to the detected error rate of the system 2900. If the stopping criteria are met, operational flow branches “yes” to a tuning module 2912. If the stopping criteria are not met, operational flow branches “no” to a sample counting operation 2914.

The sample counting operation 2914 determines whether the number of samples taken is equal to or exceeds N-Multiple of the current size of the self organizing network. If the number of samples has not been reached, operational flow branches “no” and returns to the update module 2904, allowing the system to continue its learning process. If that number of samples has been reached in the training process, operational flow branches “yes” to an insert module 2916. The insert module 2916 inserts a new node in a location (i.e. in a region) where the system nonlinearity is at its highest.

Operational flow from the insert module 2916 proceeds to a deletion module 2918. The deletion module 2918 removes at least one node which has no near neighbors. This node is in a region which the system 2900 likely cannot model well, and that node is therefore deleted.

It is understood that the growing structure competitive learning system 2900 disclosed herein can be used in conjunction with a wide variety of types of models for each region, such as a local linear model. It is further understood that multiple models can be used in implementing the present disclosure.

FIG. 30 shows an anomaly detection system 3000 in greater detail after the SOM has been trained to define a plurality of operational regions 3002. Data 3004 indicative of the operation of the dynamic system is analyzed in accordance with the plurality of operational regions 3002 to determine both a current operational region and a quantization error. If the quantization error is below a certain threshold, an error determination module 3006 passes control to an anomaly detection module 3008 for assessment of the performance via the above described techniques, i.e. TFA or local models. In some embodiments, the anomaly detection module 3008 may include a switch or trigger 3010 to enable such processing. The anomaly detection module can include one or more memories 3012 that can store normal as well as previously observed faulty operational behavior in each region in the form of a local model or time frequency moments distribution parameters (e.g. the mean vector and covariance matrix of the distribution). Using the identified current operation region, one of the records of the memory 3012 is accessed and compared to the distribution or model 3014 generated from the system output data 3016 indicative of current operation. The manner in which the distribution data or models are stored in the memory 3012 is not important for purposes of the present disclosure, and any of a number of data storage devices can be used to implement such a system 3000. In some cases, the error determination module 3006 can be coupled to one or more elements (not shown) configured to generate an alarm or other notification or data that the system 3000 is being operated outside of known, expected, or permissible limits.

FIG. 31 illustrates a diagnostic system 3100 for which performance can be evaluated, according to an example embodiment. In this example embodiment, TFA is used, but it is understood that any other predictive analysis methodology would be suitable, such as a linear model. A system 3101 includes inputs 3102, initial conditions of the outputs 3104, and outputs 3106. Regionalization can be accomplished using a SOM 3108 based on the inputs 3102 and initial conditions 3104. A model-based performance assessment technique can be directly applied within operational regions 3110 based on a current output. An assumption is made that no knowledge about the model or structure of the system 3101 is available. The only assumption is that the inputs 3102 and outputs 3106 are available when the system 3101 is operating normally.

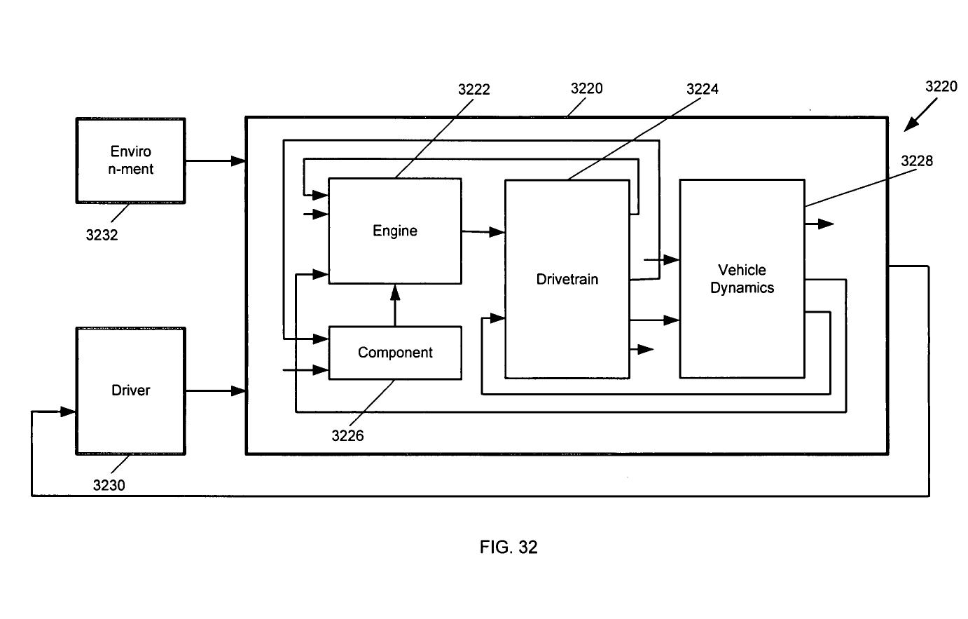

Preferably, the system 3101 is a vehicle 3120; however, the system 3120 can be any suitable system. FIG. 32 illustrates a vehicle 3220 in more detail. The vehicle 3220 includes an engine 3222, a drivetrain 3224, other components 3226, and vehicle dynamics 3228. A driver 3230 can provide inputs 3202 into the system 3201,

FIG. 32. An environment 3232 also provides inputs 3202 into the system 3201, FIG. 32, such as temperature, wind speed, road slope, and atmospheric pressure.

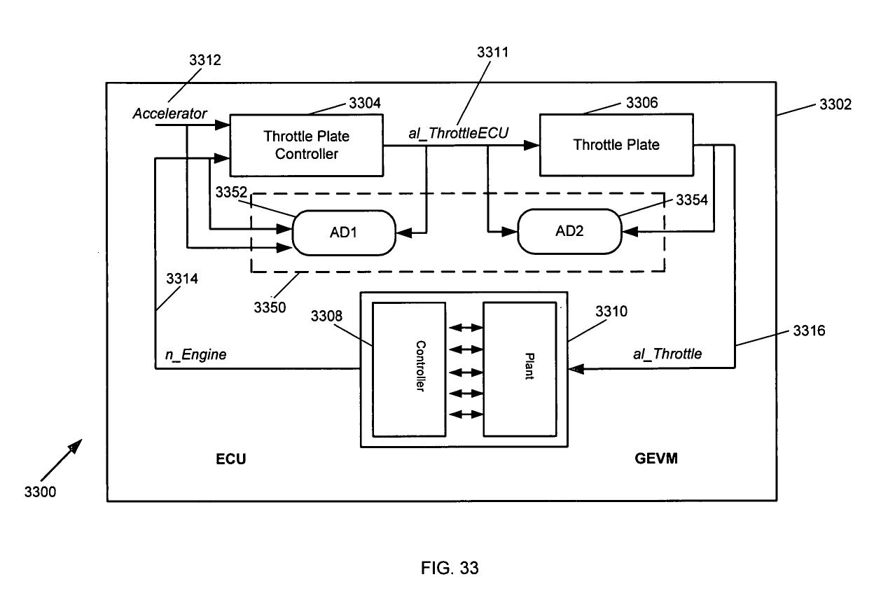

In applying the anomaly detection techniques described herein to the vehicle 3220, the vehicle 3220 might be regionalized into a first subsystem 3300, FIG. 33. In an example embodiment, the first subsystem 3300, or regionalized system, is a throttle plate subsystem 3302. The throttle plate subsystem 3302 could include a throttle plate controller 3304, a throttle plate 3306, a controller 3308 and a plant 3310.

The input, for example, the inputs 3302 of FIG. 33, to the throttle plate subsystem 3302 is a control signal 3311 from the throttle plate controller 3304, which regulates a throttle plate angle 3316 in the throttle plate 3306. The actual throttle angle is measured by sensors and fed back into the integrated system 3300. There are two inputs to the throttle plate controller 3304 when the vehicle 3320 is operating: a relative accelerator position 3312 and an engine speed 3314. Based on these two inputs 3312, 3314, the throttle plate controller 3304 calculates the control signal 3311 and sends it back to the throttle plate 3306 that sets the absolute throttle angle 3316.

An anomaly detection system 3350 detects the gradual parameter degradation of either the plant (throttle mechanism) 3310 or the controller 3308, as the system 3302 is operating. Moreover, the anomaly detection system 3350 should be able to locate any anomalies, whether the anomalies happen in the controller 3308 or in the plant 3310. Preferably, the anomaly detection system 3350 includes a first anomaly detector 3352 and a second anomaly detector 3354. The first anomaly detector 3352 detects anomalies on the control side while the second anomaly detector 3354 detects anomalies on the plant side. Each of the anomaly detectors 3352, 3354 are generated independently based on the divide and conquer approaches as described above.

In the implementation shown, the relative accelerator signal (Accelerator) 3312, the engine speed (n_Engine) 3314, the control signal (al_-ThrottleECU) 3311, and the absolute throttle angle (al_Throttle) 3316, can be sampled frequently, such as every 5 milliseconds for the case shown here, which corresponds to a sampling rate of approximately 200 Hz. In this embodiment, these signals might then be downsampled by two to reduce the sampling rate to 100 Hz. It is understood that other sampling rates can be used, and can optionally be used in conjunction with any of a number of downsampling methods.

The relative accelerator signal (Accelerator) 3312, the engine speed (n_Engine) 3314, the control signal (al_ThrottleECU) 3311, and the absolute throttle angle (al_Throttle) 3316 are first collected as the vehicle 3320 operates under normal conditions, or as determined in an IDE, for example, the IDE 800 of FIG. 8.

The following table illustrates the training and testing data sets:

| | Name of test cycles |
|---|---|
| Training data set | Japan 15 & Japan 11: Japanese cycles |
| | FTP72: USA (Federal Test Procedure of 1972) |
| | Manual driving profiles |
| Testing data set | FTP75: USA (Federal Test Procedure of 1975) |
| | ECE2: New European Test Cycle of the ECE |

The following illustrates the mechanical throttle plate 3306 within the vehicle 3320:

[image]

The input to the subsystem 3300 is labeled as al_ThrottleECU 3311, which is the control signal 3311 coming from the throttle plate controller 3304, usually ranging from 0˜1. By varying the al_ThrottleECU signal 3311, one can regulate the output of the throttle plate 3306, labeled as al_Throttle 3316, which is the absolute throttle angle, as shown above. Two parameters al_ThrottleMin and al_ThrottleDelta define the range that the throttle plate 3306 can open. The dynamics of the throttle plate 3306 are modeled as a second order dynamic system with three parameters: the mass M, the viscous damping coefficient C and the stiffness K. The nominal values for the parameters of this throttle plate 3306 are M=1, C=10, K=40, al_ThrottleDelta=80 and al_ThrottleMin=8.

The following figure illustrates the signals that are collected when all the parameters of throttle plate 3306 are set to the nominal values:

[image]

$$[ \begin{matrix}y ( {t}_{0} ) \\ \frac{ⅆ y}{ⅆ t} {\vert}_{t = {t}_{0}} \\ \frac{{ⅆ}^{2} y}{ⅆ {t}^{2}} {\vert}_{t = {t}_{0}} \\ ⋮ \\ u ( {t}_{0} ) \\ ⋮ \\ u ( {t}_{0} + τ )\end{matrix} ] … [ \begin{matrix}y ( {t}_{1} ) \\ \frac{ⅆ y}{ⅆ t} {\vert}_{t = {t}_{1}} \\ \frac{{ⅆ}^{2} y}{ⅆ {t}^{2}} {\vert}_{t = {t}_{1}} \\ ⋮ \\ u ( {t}_{1} ) \\ ⋮ \\ u ( {t}_{1} + τ )\end{matrix} ] … [ \begin{matrix}y ( {t}_{0} ) \\ ⋮ \\ y ( {t}_{0} + τ )\end{matrix} ] … [ \begin{matrix}( {t}_{1} ) \\ ⋮ \\ y ( {t}_{1} + τ )\end{matrix} ] …$$

As described above, system dynamic behaviors are partitioned into different operational regions, and within each of the regions training is necessary to establish the distribution or local model using the output sequences. This training information can be information learned from the IDE, for example IDE 800 of FIG. 8, through the DRD link 899. The example regionalization below uses time frequency analysis and a uniform size SOM for this throttle plate subsystem 3300 is based on the initial conditions of output, which is the absolute throttle angle (al_Throttle) 3316, and the input data, which is the control signal 3311 from the throttle plate controller 3304, al_ThrottleECU 3311. It is recognized that growing structure competitive learning and/or local modeling could be used to produce the predictive behavior models in regions of the SOM as well.

al_ThrottleECU is denoted as u and al_Throttle is denoted as y. To include all the information about initial conditions of output and input, we concatenate them together into a big feature vector as

$${[ y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , u ( {t}_{0} ) , … , u ( {t}_{0} + τ ) ]}^{T} ,$$

where

$$y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , …$$

are the initial value, 1^{st} derivative, and 2^{nd} derivative etc. of the system output. u(t₀), . . . , u(t₀+τ) is the input sequence during time interval [t₀,t₀+τ]. The corresponding output sequence is [y(t₀), . . . , y(t₀, +τ)]^{T}. Similarly, one can shift the window of length r to another start point t₁, giving another big feature vector

$${[ y ( {t}_{1} ) , \frac{ⅆ y}{ⅆ t} {\vert}_{t = {t}_{1}} , \frac{{ⅆ}^{2} y}{ⅆ {t}^{2}} {\vert}_{t = {t}_{1}} , … , u ( {t}_{1} ) , … , u ( {t}_{1} + τ ) ]}^{T}$$

and its corresponding output sequence [y(t₁), . . . ,y(t₁+τ)]^{T} as illustrated. In this way, two sets of vectors are collected: one containing all the information of the initial conditions of the output together with the input sequence, and the other consisting of the output sequence of the same time interval. Moreover, there is a one-to-one correspondence between these two sets of feature vectors.

In some instances, only the signals with highly dynamic inputs might be used for training and later used for testing. Relatively static inputs may not stimulate dynamic modes of the system and hence would not reveal faults caused by dynamic system parameter drifts. Therefore, to detect static changes (such as the gain change) as well as dynamic changes of the system, the training set of only rapidly changing signals can be used. One possible way is to set a threshold on the variance of the input sequences. Only the input sequences whose variances are greater than the predefined threshold are selected as a training set. Although this may not be the optimal way, it is easier to implement.

After collecting all the feature vectors, regionalization can be done using SOM based on the vectors consisting of input sequence and initial conditions of output. In this example embodiment for the throttle plate subsystem 3302, a data sequence length is chosen as 0.6 seconds, which corresponds to 60 points after the original data has been downsampled by two, as described above. For the initial conditions of output, only the initial value, and the first and second derivatives are included. Since the input to the throttle plate subsystem 3302 is a number from 0˜1, no normalization is necessary for the input sequence. The initial conditions of the output, including the initial value, and the first and second derivatives, has been normalized using the following formula:

$${X}_{normalized} = \frac{X - E ( X )}{{σ}_{X}}$$

where E(X) and σₓ are the mean and the deviation of variable X. This step is necessary to eliminate the situation in which there is huge magnitude of difference in the feature vector elements, because the features of big magnitude will dominate the effects on the resulting SOM. An example software package that can be used is SOM Toolbox, Alhoniemi, E., Himberg, J., Kiviluoto, K., Parviainen, J. and Vesanto, J. (1997), SOM toolbox for Matlab, available via WWW at fttp://www.cis.hut.fi/somtoolbox/.

Note that while collecting the training data, regionalization is done using the SOM and growing model, based on the input sequence and initial conditions of output.

Relatively static inputs do not stimulate dynamic modes of the system and hence cannot reveal faults caused by dynamic system parameter changes. Therefore, to detect the gain change parameter (which is a change in a static system parameter) as well as dynamic change parameter of the system, the training set of only rapidly changing signals might be used. One possible way is to set a threshold on the variance of the input sequences, and select for training or later for testing only the input sequences whose variances are greater than the predefined threshold.

In creating the SOM, there is a trade-off between a degree of generalization and quantization accuracy of SOM. A small SOM has good generalization of the training feature vectors but poor quantization accuracy. A large SOM can have high quantization accuracy, but the training feature vectors are not well generalized, and it consumes more computation power. Two possible SOMs obtained from the training process are illustrated below, although there is no constraint that operational regions remain the same size (and in most instances will not be):

[image]

In the case of local models, the SOM size selection process is largely eliminated, as the size of the SOM created is based on minimizing the square of the expected modeling error, E[∥y−ŷ(s)∥²]. This splitting strategy promotes evenly distributed accumulated modeling error, a tradeoff between density approximation and nonlinearity optimization.

While the SOM is training by determining expected modeling error, the distribution or models update, therefore updating the expected error or variance threshold within the region. As more normal data is collected by the system, the expected modeling error or variance is reduced and the SOM converges to a relatively stable state. Once the models are fully trained, the anomaly detector can be used to accurately compare actual output to the modeled output.

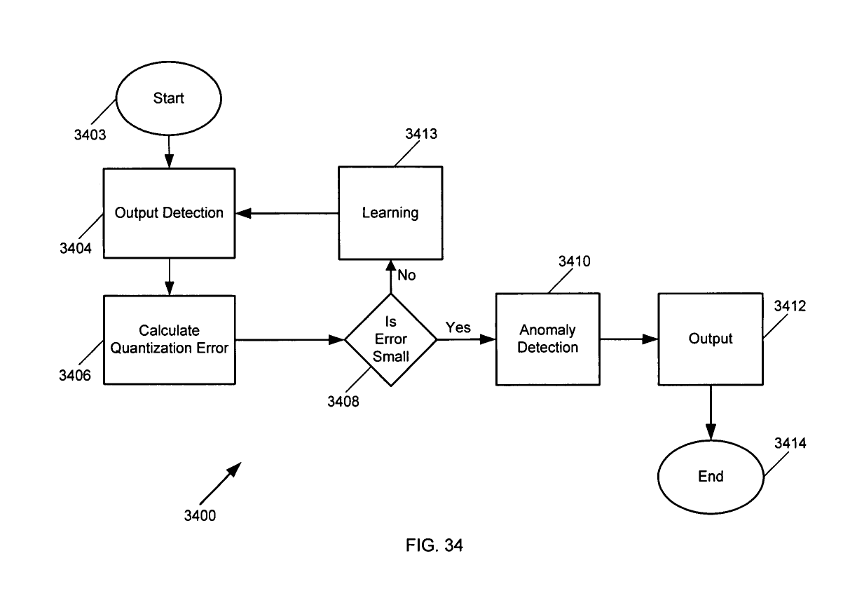

FIG. 34 illustrates a logical flow diagram of an anomaly detector 3400. Operational flow begins at a start terminal 3402. An output operation 3404 allocates a current output, and its corresponding inputs and initial conditions, into an operational region. A calculate operation 3406 calculates a quantization error.

An error module 3408 determines if the quantization error is smaller than a preset threshold, which is the distance from the observed vector or inputs and initial conditions to the best matching unit in the SOM. If the error module 3408 determines that the quantization error is not smaller than the predetermined threshold, operational flow branches “NO”, indicating the presence of a newly observed operating condition. Operational flow proceeds to a learning module 3413, which triggers additional development of the anomaly models or distributions consistent with the disclosure above. No alert is triggered, because no model exists for the region near the newly observed vector of inputs and initial conditions. If the error module 3408 determines that the quantization error is smaller, operational flow branches “YES” to an anomaly operation 3410 and an anomaly detection alert is triggered in an output module 3412. Operational flow ends at terminal point 3414.

The logical flow of the anomaly detector of FIG. 34 is seen in the following figure, which illustrates some example results of the anomaly detector on the throttle plate subsystem 3302 of FIG. 33:

[image]

The horizontal axis shows the system parameter values, and each point represents the mean of confidence values when the system parameter is set to the specified value as indicated in along x axis. Such comparisons can be made within each trained region. In addition, the 3-σ limits are also illustrated as intervals made of short solid lines. As discussed herein previously, the nominal values for viscous damping coefficient C and stiffness K are 10 and 40 respectively. It can be observed that as the parameters degrade away from the nominal value, the confidence value drops down. This in turn provides an indication that the system performance is deviating away from the normal behaviors. Similar trends have also been observed for the other two parameters, the mass M and the ThrottleDelta. This indicates the anomaly detector is capable of detecting different kinds of anomalies and the gradual degradation of the system parameters without a priory presenting signatures characterizing those faults to the anomaly detector.

Unlike the throttle plate 3306, FIG. 33, where there is only one input, the throttle plate controller 3304 has two inputs: Accelerator 3312 and n_Engine 3314. A parameter can be introduced into the throttle plate controller 3304 to scale one of the tables in the nonlinear throttle plate controller 3304. The nominal value for this gain factor is 1 and the following figure illustrates the sample signals collected when the gain factor is set to its nominal value:

[image]

Like the anomaly detection on the plant, a similar procedure can also be applied here. Regionalization is based is on two input sequences from Accelerator 3312 and n_Engine 3314 and the initial conditions of the output al_ThrottleECU 3311. A SOM is created during the training process based on the training data to regionalize the system dynamics behaviors, and local models are also computed and updated as training data is introduced. After the training is complete, the controller detector is likewise tested.

After the training is complete, the controller detector has been tested on the testing data. The following figure illustrates the results from the anomaly detector associated with the controller:

[image]

In this example, it can be observed that as the gain factor of the controller is reduced from its nominal value of 1 to 0.65, the confidence value decreases, while the variance increases.

Individual anomaly detectors are capable of sensing gradual degradations of system parameters. If we combine the results from different anomaly detectors, we can also locate the anomalies using a hierarchical root cause identification. To demonstrate this capability, two scenarios are discussed. In the first scenario, the stiffness K, which is a parameter of the plant, is made to gradually decrease from the nominal value 40 to 24 in about 700 seconds. Other parameters including parameters of the controller and the plant, are kept at their nominal values. In the second scenario, disturbance is introduced to the gain factor, which is a parameter of the controller, and is also made to exponentially decrease from the nominal value 1 to 0.6 in about 700 seconds. The following illustrates the time varying parameters in the two scenarios.

[image]

The two anomaly detectors discussed previously are then tested on standard driving profiles, which are not used for training. The first scenario is tested on a first driving profile ECE2, and the second scenario is tested on a second driving profile FTP75. These two particular driving profiles correspond to driving profiles within LABCAR®, a product of ETAS. The following illustrates the anomaly detection results:

[image]

In order to filter out the noise, the exponential weighted moving average (EWMA) operator can be applied to the confidence values. The straight line across the window is the lower control limit that has been calculated based on the statistics of the confidence values observed on the training data set.

It can be observed, that for the first scenario, the confidence values from the controller are high all the time, but the confidence values from the anomaly detector on the plant gradually decrease and finally go out of the control limits. This indicates that an anomaly occurred in the plant but the controller is still operating normally. For the second scenario, since disturbance was introduced into the controller parameter, the confidence values from the controller anomaly detector decrease and go out the control limits, while the confidence values from the plant anomaly detector remain within the control limit. Thus, one can easily determine the location of the anomalies, in the controller, the plant, or both. The ability to decouple plant and controller anomalies as demonstrated is important for finding the locations of the anomalies.

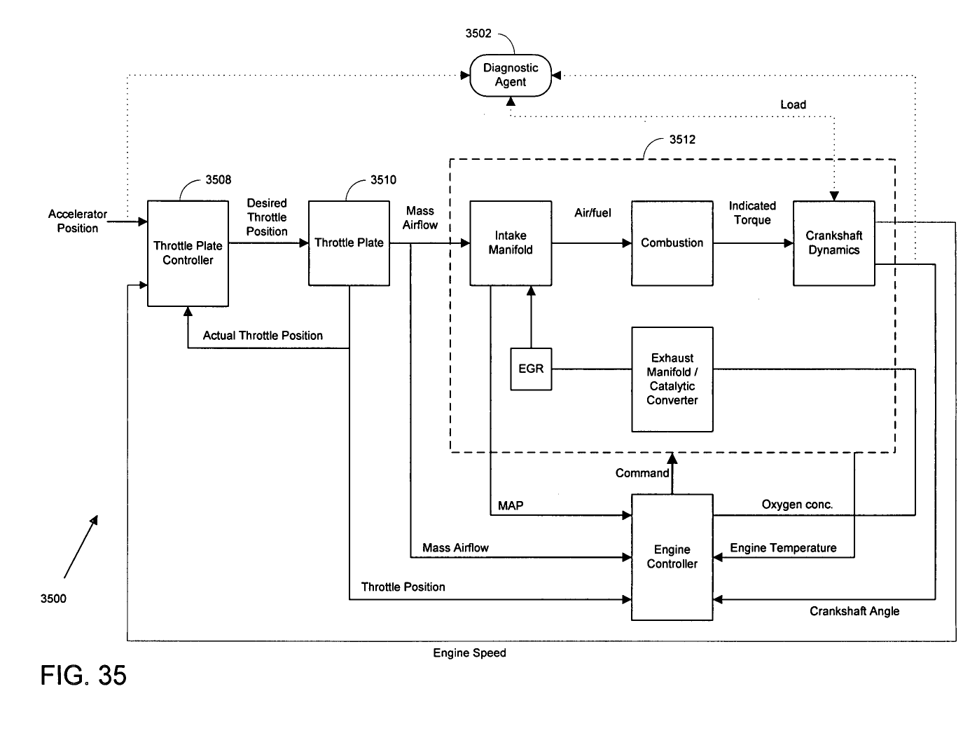

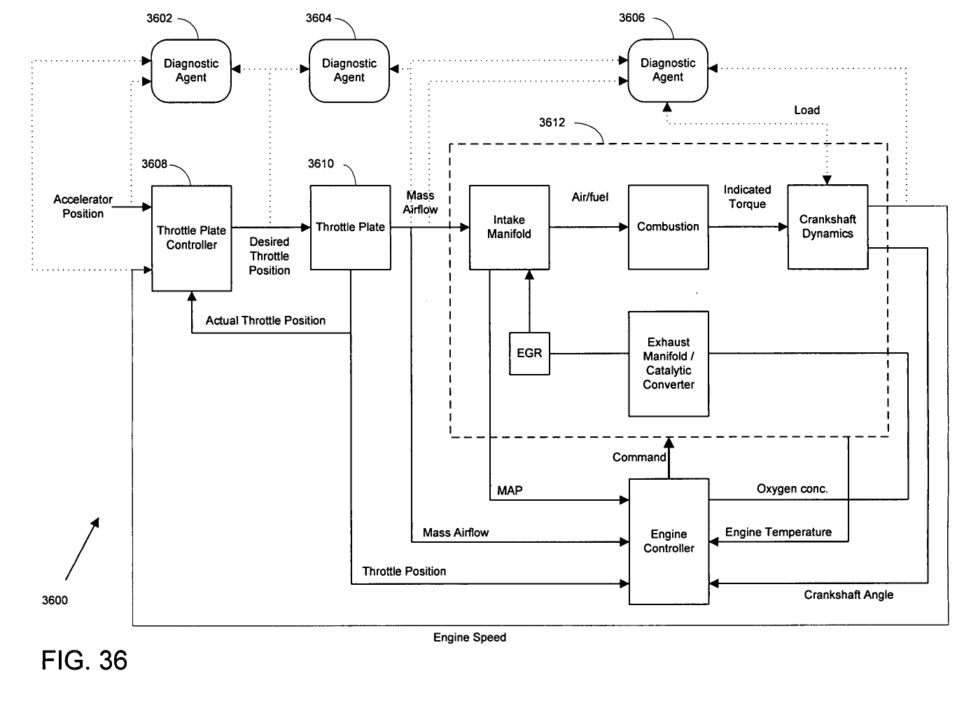

FIGS. 35-36 show a schematic representation of a root cause identification system according to an exemplary embodiment of the present disclosure. Specifically, FIGS. 35-36 show two possible configurations of a hierarchical root cause identification system 3500, 3600 as connected to a gasoline engine vehicle model exhibiting further embodiments of root cause identification. Generally speaking, multiple diagnostic agents distributed throughout a control system may target the set of faults known a priori.

In the embodiment shown in FIG. 35, the system 3500 has a diagnostic agent 3502 connected across a throttle plate controller 3508, throttle plate 3510, and engine system 3512. In contrast, the embodiment shown in FIG. 35 shows a system 3600 having separate, dedicated diagnostic agents 3602, 3604, 3606 trained on the throttle plate controller 3608, throttle plate 3610, and engine system 3612, respectively.

In considering both FIGS. 35 and 36, the distribution of diagnostic agents 3502, 3602, 3604, 3606 involves a hierarchical control architecture, in which a primitive fault tree is provided by distributing the diagnostic agents through the overall system 3500, 3600. Such hierarchical decomposition of the system can be applied for purposes of fault isolation. FIG. 35 shows a system 3500 in which the lowest level at which a diagnostic agent is located is at the engine control subsystem. In the system 3500, the anomaly detector can determine whether a system anomaly occurs in the subsystem shown by determining if the anomaly is detected by diagnostic agent 3502. FIG. 36 shows a system 3600 in which each component has a dedicated diagnostic agent 3602, 3604, 3606. The system 3600, having a larger number of diagnostic agents dedicated to smaller subcomponents of the system, allows for narrower root cause isolation of potential anomalies in the system.

In operation, the root cause identification system may isolate a fault through the identification of the lowest level segment of the system on which a diagnostic agent has detected a fault. In the embodiment shown in FIG. 35, that would be the GEVM. In the embodiment shown in FIG. 36, the error could be traced down to the throttle plate controller 3608, throttle plate 3610, or engine system 3612. Of course, other subsystems or components of the tested system can have diagnostic agents dedicated thereto as well. For example, one diagnostic agent may be configured to detect an anomalous connection between accelerator position and rotational speed of the engine with the throttle valve position, an additional diagnostic agent can observe the condition of the controller of the electronic throttle mechanism, and the condition of the throttle mechanism.

A further embodiment of the root cause identification system, which can be used in conjunction with hierarchical root cause identification, requires a number of diagnostic agents specialized to identify specific failure modes. In this approach, separate diagnostic agents such as those described herein are specifically trained to detect designated failure mode, such as at some predetermined threshold.

This alternate embodiment is best illustrated with an example. For purposes of example, the faults are identified herein as F0, F1, F2, and F3. Further, it is assumed that the input-output signals corresponding with the faults F0, F1, and F2 are known, while the signature of fault F3 is unknown. So, a system is trained using the known operating condition data for the three known faults consistent with the present disclosure. In this case, the operating condition data corresponding with the fault replaces the data corresponding to normal operational behavior. So, using TFA for example, a distribution of vector moments may be generated for each fault. Instead of a confidence value for whether the system is operating normally as described with general anomaly detection above, in this case the confidence value is to whether the diagnostic agent detects its particular trained error with confidence. The fault may thus be detected by the simultaneous drop in the confidence level of the normal behavior diagnostic agent measuring proximity to normal behavior, along with the growth in confidence level of the diagnostic agent associated with the known fault. This indicates proximity of the tested system's behavior to the particular fault for which that second diagnostic agent is trained.

Using the foregoing example assumptions, the following signature may be seen by the normal operation diagnostic agent as well as the diagnostic agents trained to detect specific errors:

[image]

It is apparent in the above signature that from time 0-500, the F0 error is occurring, because the F0 diagnostic agent has high confidence in its occurrence, simultaneously to relatively low confidence values for other diagnostic agents. The same can be said for the F1 error between times 500 and 1500, as well as F2 between times 2500 and 3500. In the timeframe between times 1500 and 2500, none of the diagnostic agents have a confidence value above their determined threshold. This is consistent with the index, which shows that error F3 is occurring at this point. Because no diagnostic agents are trained to recognize F3, it may be an undetected anomaly that can be root caused using a combination of this method and the hierarchical methods previously described.

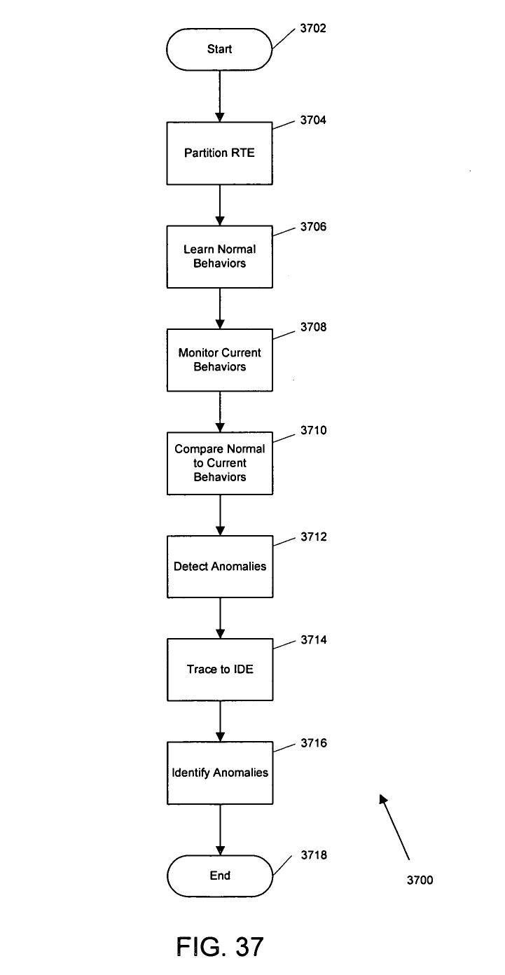

FIG. 37 is an example flow diagram of an anomaly detection system 3700 according to a specific embodiment. The anomaly detection system 3700 can be used, for example, in multiple aspects of the error detection system, such as in the diagnostic agent or for the failure mode root cause detection described above. Operational flow begins at a start point 3702. A partition operation 3704 partitions a run-time environment into at least one operational region. This partitioning can be called regionalization. A learn operation 3706 learns known behaviors operating within the operational region. This learning can be called training. A monitor operation 3708 monitors current behaviors. A compare operation 3710 compares the known behaviors to the current operating behaviors. A detect operation 3712 detects behavior modes when a deviation exists between the current operating behaviors and the known operating behaviors. A trace operation 3714 can trace the unknown behavior modes back to an integrated development environment through a link. An identify operation 3716 identifies the unknown anomalies in the integrated development environment based on the tracing of the anomalies.

As discussed herein, a novel root cause identification system that is capable of localizing anomalies is disclosed. The proposed approaches do not require detailed knowledge of the system dynamics. The existence of normal inputs and outputs signals is the only assumption for the proposed method.

This approach is capable of building the input-output relationship statistically through SOM based regionalization and local model based performance assessment using the normal input-output signals, regardless of system type, linear or nonlinear. The model building process is quite efficient. This significantly reduces the development time of the diagnostic system.

The disclosed method has been demonstrated on a subsystem of a gasoline engine vehicle model. It has been shown that the anomaly detector can detect and can root cause different kinds of parameter drifts of the system. Moreover, the multiple anomaly detectors can decouple the plant and controller anomalies. Based on the results of the anomaly detectors, one can localize the anomalies in the plant, controller, or both.

One skilled in the art would recognize that the system described herein can be implemented using any number of software configurations, network configurations, hardware configurations, and the like.

The logical operations of the various embodiments illustrated herein are implemented (1) as a sequence of computer implemented steps or program modules running on a computing system and/or (2) as interconnected logic circuits or circuit modules within the computing system. The implementation is a matter of choice dependent on the performance requirements of the computing system implementing the invention. Accordingly, the logical operations making up the embodiments of the present invention described herein are referred to variously as operations, steps, engines, or modules.

The above specification, examples and data provide a complete description of the manufacture and use of the composition of the invention. Since many embodiments of the invention can be made without departing from the spirit and scope of the invention, the invention resides in the claims hereinafter appended.

1. A system for identifying anomalies comprising:
a plurality of anomaly detection agents trained to detect anomalies in a tested system, each anomaly detection agent interfaced with a subsystem of the tested system to detect known anomalies occurring in that subsystem;
a root cause isolation tool configured to identify potential root causes for anomalies occurring during actual operation of the tested system based on data from the anomaly detection agents.

2. The system of claim 1, wherein:
the subsystem of the tested system is a hierarchical level of the tested system.

3. The system of claim 1, wherein the root cause isolation tool is configured to determine the lowest hierarchical level at which the anomalies occur.

4. The system of claim 1, wherein:
the plurality of anomaly detection agents are configured to detect the anomalies by comparing actual operational behavior to normal operational behavior.

5. The system of claim 1, wherein:
the plurality of anomaly detection agents are configured to detect the anomalies by comparing actual operational behavior to known faulty operational behavior.

6. The system of claim 1, wherein:
the plurality of diagnostic agents are configured to use time frequency analysis to detect the anomalies.

7. The system of claim 1, wherein:
the plurality of anomaly detection agents are configured to use local linear models to detect the anomalies.

8. A method for identifying root causes of anomalies in a tested system, the method comprising:
detecting anomalies in the tested system by generating data representing a comparison of actual operational behavior of the tested system to normal operational behavior of the tested system;
compressing the data into patterns; and
determining a set of probable root causes for each of the anomalies, the probable root causes based on the patterns.

9. The method of claim 8, wherein:
detecting includes inserting a plurality of diagnostic agents at hierarchical levels of the complex system.

10. The method of claim 8, wherein:
determining comprises locating a lowest hierarchical level in the system at which each of the anomalies is detected.

11. The method of claim 8, wherein:
detecting includes detecting a failure mode in each of a plurality of diagnostic agents.

12. The method of claim 11, wherein:
detecting includes comparing known faulty operational behavior to actual operational behavior to detect the failure mode.

13. The method of claim 8, wherein:
detecting includes using local linear models to determine normal operational behavior.

14. The method of claim 8, wherein:
detecting includes using time frequency analysis and time frequency moments to determine normal operational behavior.

15. The method of claim 8, wherein:
detecting includes using local linear models to determine known operational behavior.

16. The method of claim 8, wherein:
detecting includes using time frequency analysis and tine frequency moments to determine known operational behavior.

17. The method of claim 8, wherein:
compressing includes using principle component analysis of the comparison data to generate the patterns.

18. A computer program product readable by a computing system and encoding instructions for identifying root causes of anomalies in a tested system, the computer process comprising:
detecting anomalies by generating data representing a comparison of actual operational behavior of the tested system to normal operational behavior of the tested system;
compressing the data into patterns; and
determining a set of probable root causes for each of the anomalies, the probable root causes based on the patterns.

19. The computer program product of claim 18, wherein:
detecting includes inserting a plurality of diagnostic agents at hierarchical levels of the complex system.

20. The computer program product of claim 18, wherein:
determining comprises locating a lowest hierarchical level at which an anomaly is detected.

21. The computer program product of claim 18, wherein:
detecting includes detecting a failure mode in a diagnostic agent.

22. The computer program product of claim 21, wherein:
detecting includes comparing known operational behavior to actual operational behavior to detect the failure mode.

23. The computer program product of claim 18, wherein:
detecting includes using local linear models to determine normal operational behavior.

24. The computer program product of claim 18, wherein:
detecting includes using time frequency analysis to determine normal operational behavior.

25. The computer program product of claim 18, wherein:
determining includes using local linear models to determine known operational behavior.

26. The computer program product of claim 18, wherein:
determining includes using time frequency analysis to determine known operational behavior.

27. The computer program product of claim 18, wherein:
compressing includes using principle component analysis of the comparison data to generate the patterns.

28. A method of detecting a performance anomaly in a dynamic system in operation, the method comprising the steps of:
identifying a current operational region of a plurality of operational regions based on the operation of the dynamic system; and,
comparing the operation of the dynamic system with normal operational behavior within the current operational region to calculate a performance indication of a degree of deviation from the normal operational behavior within the current region.

29. The method of claim 28, wherein:
the plurality of operational regions partition the normal operational behavior of the dynamic system via vector quantization.

30. The method of claim 29, wherein:
the vector quantization technique comprises a hierarchal vector quantization.

31. The method of claim 29, wherein:
the vector quantization comprises a self-organizing map trained in accordance with data indicative of the normal operational behavior within each operational region of the plurality of operational regions.

32. The method of claim 31, wherein:
the identifying step comprises determining a best matching unit in the self-organizing map for the operation of the dynamic system.

33. The method of claim 32, wherein the identifying step comprises the steps of:
calculating a quantization error between a weight vector associated with the best matching unit and a vector associated with the operation of the dynamic system; and,
triggering a calculation of the performance indication when the quantization error is lower than a predetermined threshold.

34. A computer program product readable by a computing system and encoding instructions for identifying root causes of anomalies in a tested system, the computer process comprising:
identifying a current operational region of a plurality of operational regions based on the operation of the dynamic system; and,
comparing the operation of the dynamic system with normal operational behavior within the current operational region to calculate a performance indication of a degree of deviation from the normal operational behavior within the current region.

35. The computer program product of claim 34, wherein:
the plurality of operational regions partition the normal operational behavior of the dynamic system via vector quantization.

36. The computer program product of claim 35, wherein:
the vector quantization comprises a self-organizing map trained in accordance with data indicative of the normal operational behavior within each operational region of the plurality of operational regions.
